(19) United States
(12) Patent Application Publication
(10) Pub. No.: US 2007/0002284 A1
(43) Pub. Date: Jan. 4, 2007

(54) Method for manufacturing projection optical system and projection optical system

(75) Inventors: Masayuki Imaoka, Izumiotsu-shi (JP); Atsushi Matsuura, Sakai-shi (JP); Takuji Hatano, Suita-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/475,491

(22) Filed: Jun. 27, 2006

(30) Foreign Application Priority Data
Jun. 30, 2005 (JP) 2005-191684
Apr. 27, 2006 (JP) 2006-123967

(51) Int. Cl. G03B 21/28

(52) U.S. Cl. 353/78

(57) ABSTRACT

A projection optical system has lower and upper pedestal components to which a plurality of mirrors are attached. Of the mirrors, a concave mirror is placed closest to a DMD, and a convex mirror is next to the concave mirror. A position and an inclination of the convex mirror is fixed. At least three axes for a position and an inclination of the concave mirror is adjusted.

### RELATED APPLICATION

This application is based on Japanese Patent Applications Nos. 2005-191684 and 2006-123967, the contents in which are incorporated herein by reference.

### BACKGROUND OF THE INVENTION

The present invention relates to a manufacturing method for a projection optical system and a projection optical system suitable for implementing the same.

Projection type image display apparatuses include a rear projection television, video projector, or other projection-type image display apparatuses having a reflection-type image formation device such as a DMD (Digital Micromirror Device) or the like, or a transmission-type image formation device such as a transmission-type liquid crystal device or the like

Projection optical systems which enlarge and project images formed by an image formation device in a projection-type image display apparatus can be broadly divided into refraction optical systems, mainly comprising lenses and other optical elements, and reflection optical systems, mainly comprising mirrors and other optical elements. In general, since the reflection optical system has no chromatic aberration, it has advantage that finer images can be obtained.

Various techniques have been proposed regarding optical adjustment in the projection type image display apparatus. For example, Japanese Patent Application Laid-Open Publication No. 2-195384 discloses an adjustment mechanism for a three-panel liquid crystal projector, in which a first liquid crystal panel is fixed onto a composition optical means including a dichroic prism and the alignment positions of remaining second and third liquid crystal panels with the first liquid crystal panel are adjusted.

In the case where the refraction optical system is employed as the projection optical system, only the adjustment of the image formation device is necessary and the adjustment of the projection optical system is not necessary. In the case of the reflection optical system which is a non-axial system, a positional relationship between an image formation device and a mirror and a positional relationship between mirrors has a large influence on optical performance. In other words, the reflection optical system is sensitive to the positional relationship between the image formation device and the mirror and the positional relationship among mirrors. Consequently, in the case where the reflection optical system is employed as the projection optical system, adjustment of a plurality of mirrors is necessary, which requires a relatively long time as compared with the case where the refraction optical system is employed as the projection optical system. Therefore, it is not necessarily easy to attain desired optical performance.

### SUMMARY OF THE INVENTION

An object of the present invention is to provide a method for manufacturing a projection optical system constituted by a refraction optical system, the method allowing attainment of desired optical performance by effectively implemented adjustment procedures. Another object of the present invention is to provide a projection optical system suitable for implementing such manufacturing method.

A first aspect of the present invention provides a method for manufacturing a projection optical system. The method comprises followings: attaching the mirrors to a pedestal, the mirrors including a first mirror placed closest to the image formation device on an optical path traveling from the image formation device to the screen and a second mirror placed next to the first mirror on the optical path; fixing a position and an inclination of the second mirror; and adjusting at least three axes for a position and an inclination of the first mirror.

Since the position and the inclination of the second mirror are fixed and not subject to adjustment, the time necessary for adjusting the projection optical system is shortened during manufacturing and desired optical performance can be attained easily. Moreover, since a mechanism for adjusting the position and the inclination of the second mirror is not necessary, it is possible to simplify the structure of the projection optical system and to reduce the number of component parts.

Specifically, the adjustment of the position and the inclination of the first mirror includes a translation along a first axis, a rotation around a second axis, and a rotation around a third axis. A light beam passing an optical path traveling through a center of the image formation device and a center of an aperture of the projection optical system to a center of the screen is defined as a reference light beam. The first axis is an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror. The second axis is an axis parallel to the incidence plane of the reference light beam to the first mirror and perpendicular to the first axis. The third axis is an axis perpendicular to the first and second axes is defined as a third axis.

According to the manufacturing method in the first aspect, adjustment of the position and inclination of the image formation device attached to the pedestal can be executed after the adjustment of the position and the inclination of the first mirror by a translation of the image formation device along a short side thereof and a movement of the image formation device along a long side thereof.

Moreover, the position of the image formation device may be further adjusted by a rotation of the image formation device around an axis along a normal axis of the image formation device.

The second mirror is attached to the projection optical system after completion of separate procedures in which a position and a inclination of the second mirror to a mirror holder for holding the second mirror are adjusted. Specifically, in the first aspect of the present invention, the second mirror is fixed to the mirror holder which is to be fixed to the pedestal after the second mirror is fixed. The mirror holder is fixed to the pedestal after adjustment of at least three axes for the position and the inclination of the second mirror to the mirror holder. In case that the second mirror is a spherical surface mirror, the adjustment of the position and the inclination of the second mirror to the mirror holder can be executed using a collimator. Further, a master engine and length gauge (length measuring machine) respectively can be used for adjusting the position and the inclination of the second mirror to the mirror holder.

The manufacturing method according to the first aspect is applicable to a projection optical system including at least four curved mirrors with a first mirror being a concave mirror and a second mirror being a convex mirror. Mirror surfaces may be any one of a spherical surface, an aspherical surface and a free-form surface.

A second aspect of the present invention provides a method for manufacturing a projection optical system having a plurality of mirrors which reflect an image light modulated by an image formation device so as to be projected onto a screen. The method comprises followings: attaching the mirrors to a pedestal, the mirrors including a first mirror placed closest to the image formation device on an optical path traveling from the image formation device to the screen and a second mirror placed next to the first mirror on the optical path; fixing a position and an inclination of the image formation device; and adjusting at least three axes for a position and an inclination of the first mirror.

The position and the inclination of the image forming apparatus are fixed so that their adjustment is not necessary. Instead, at east three axes are adjusted for the position and the inclination of the first mirror. Therefore, the time necessary for adjusting the projection optical system is shortened and desired optical performance can be attained easily. Moreover, since a mechanism for adjusting the position and the inclination of the image formation device is not necessary, it is possible to simplify the structure of the projection optical system and to reduce the number of component parts.

More specifically, the adjustment of the position and the inclination of the first mirror includes a translation along a first axis, a translation along a second axis, and a translation along a third axis. The reference light beam is a light beam passing an optical path traveling through a center of the image formation device and a center of an aperture of the projection optical system to a center of the screen. The first axis is an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror. The second axis is an axis parallel to the incidence plane of the reference light beam to the first mirror and perpendicular to the first axis. The third axis is an axis perpendicular to the first and second axes.

Further, in order to adjust the projection position of an image on the screen, the second mirror is translated together with the first mirror after the adjustment of the position and inclination of the first mirror. Specifically, an axis passing an intersection between the reference light beam and the second mirror, existing in an incidence plane of the reference light beam to the second mirror, and directed to a direction between an incident direction of the reference light beam to the second mirror and a reflection direction of the reference light beam from the second mirror is defined as a fourth axis. Further, an axis parallel to the incidence plane of the reference light beam to the second mirror and perpendicular to the fourth axis is defined as a fifth axis. Furthermore, an axis perpendicular to the fourth and fifth axes is defined as a sixth axis. At least one of first and second adjustments is executed after adjustment of the position and the inclination of the first mirror. The first adjustment includes the translation of the first mirror along the first axis by an amount and a translation of the second mirror along the fifth axis by same amount. On the other hand, the second adjustment includes the translation of the first mirror along the third axis by an amount and a translation of the second mirror along the sixth axis by same amount.

The manufacturing method in the second aspect is applicable to a projection optical system including at least four curved mirrors with a first mirror being a concave mirror and a second mirror being a convex mirror, and the mirror surface may be any one of a spherical surface, an aspherical surface and a free-form surface.

Preferably, an image formation device holder to which the image formation device is attached is mounted on the pedestal in such a way that an inclination between a mounting reference plane for mounting the image formation device holder on the pedestal and the image formation surface of the image formation device is not more than ⅙ degree.

A third aspect of the present invention provides a projection optical system comprising, a plurality of mirrors which reflect an image light modulated by an image formation device so as to be projected onto a screen, which includes a first mirror placed closest to the image formation device on an optical path traveling from the image formation device to the screen and a second mirror placed next to the first mirror on the optical path, a pedestal on which the image formation device, the first mirror, and the second mirror are mounted, and a mirror adjustment mechanism for supporting the first mirror so that the first mirror can be translated along a first axis, rotated around a second axis, and rotated around a third axis with respect to the pedestal, the first axis being an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror, the second axis being an axis parallel to the incidence plane of the reference light beam to the first mirror and perpendicular to the first axis, and the third axis being an axis perpendicular to the first and second axes.

The projection optical system of the third aspect allows implementation of the manufacturing method of the first aspect, that is, the adjustment method in which the second mirror is fixed so that the position and the inclination thereof are not subject to adjustment and three axes are adjusted for the position and the inclination of the first mirror.

Specifically, the mirror adjustment mechanism comprises, a mirror holder for holding the first mirror, a mirror holder base fixed onto the pedestal, a holder retainer for retaining the mirror holder onto the mirror holder base in such a way as to allow parallel translation of the mirror holder in the first axis direction but to restrict translation of the mirror holder in the second and third axes directions, and a positioning mechanism capable of positioning at least three portions of the mirror holder with respect to the mirror holder base in the first axis direction, the three portions being disposed symmetrically with respect to a first symmetric axis parallel to the second axis passing a center of the first mirror and a second symmetric axis parallel to the third axis passing the center of the first mirror.

A fourth aspect of the present invention provides a projection optical system comprising, a plurality of mirrors which reflect an image light modulated by an image formation device so as to be projected onto a screen, which includes a first mirror placed closest to the image formation device on an optical path traveling from the image formation device to the screen and a second mirror placed next to the first mirror on the optical path, a pedestal on which the image formation device, the first mirror, and the second mirror are mounted, and a mirror adjustment mechanism for supporting the first mirror so that the first mirror can be translated along a first axis, translated along a second axis, and translated along a third axis with respect to the pedestal, the first axis being an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror, the second axis being an axis parallel to the incidence plane of the reference light beam to the first mirror and perpendicular to the first axis, and the third axis being an axis perpendicular to the first and second axes.

Desired optical performance of the projection optical system of the fourth aspect can be attained by the manufacturing method of the second aspect, that is, the adjustment method in which the image formation device is fixed so that the position and the inclination thereof are not subject to adjustment and three axes are adjusted for the position and the inclination of the first mirror by the adjustment mechanism.

Specifically, the mirror adjustment mechanism comprises, a first adjustment plate mounted on the pedestal displaceably in the first axis direction, a second adjustment plate mounted on the first adjustment plate displaceably in the third axis direction, and a mirror holder for holding the first mirror mounted on the second adjustment plate displaceably in the second axis direction.

The projection optical systems of the third and fourth aspects may comprise an optical path length adjustment mechanism which including a pair of wedge-type optical elements placed between the image formation device and the first mirror and having inclined surfaces inclined with respect to a normal direction of a image formation surface and contacted with each other, and a position adjustment mechanism capable of adjusting relative positions of the optical elements with maintaining the inclined surfaces being in contact with each other.

Adjusting the position of the first mirror in the normal direction of the image formation surface of the image formation device by the optical path length adjustment mechanism allows back-focus adjustment after the adjustment of the position and inclination of the first mirror.

The projection optical systems of the third and fourth aspects may comprise a focus adjustment mechanism for adjusting a position of the image formation device in the normal direction of the image formation surface with respect to the first mirror. For example, the focus adjustment mechanism comprises an image formation device holder for holding the image formation device, an attachment member fixed to the pedestal, a supporting mechanism for supporting the image formation device holder to the attachment member so as to be moved forward and backward with respect to the image formation device holder, a urging member for elastically urging the imager formation device holder toward a direction where the image formation device holder approaches the attachment member, and a adjustment member rotatably held between the image formation device holder and the attachment member for moving the image formation device holder in a direction away from the attachment member against an urging force of the urging member according to a rotational position thereof.

According to the manufacturing methods of the first and second aspects, the time necessary for adjusting the projection optical system can be shortened and desired optical performance can be attained easily. Further, it is possible to simplify the structure of the projection optical system and to reduce the number of component parts. The projection optical systems of the third and fourth aspects can be manufactured by the first and second aspect having such effects.

### BRIEF DESCRIPTION OF THE DRAWINGS

These and other objects and features of the invention will become apparent from the following description taken in conjunction with preferred embodiments of the invention with reference to the accompanying drawings, in which:

FIG. 1 is a schematic view showing a rear projection TV to which a manufacturing method for a projection optical system of a first embodiment of the present invention can be applied;

FIG. 2 is an external perspective view showing an illumination optical system unit and a projection optical system unit;

FIG. 3 is a cross sectional view taken along a line III-III in FIG. 2;

FIG. 4 is a cross sectional view taken along a line IV-IV in FIG. 2;

FIG. 5 is a perspective view showing a lower pedestal component viewed from the rear side;

FIG. 6 is a perspective view showing a convex mirror adjustment mechanism in the first embodiment;

FIG. 7 is a front view showing the convex mirror adjustment mechanism in the first embodiment;

FIG. 8 is a plane view showing the convex mirror adjustment mechanism in the first embodiment;

FIG. 9 is a right side view showing the convex mirror adjustment mechanism in the first embodiment;

FIG. 10 is an enlarged partial view of FIG. 8;

FIGS. 11A and 11B are flowcharts for explaining adjustment procedures in the manufacturing method for the projection optical system according to the first embodiment of the present invention;

FIG. 12 is a perspective view showing a convex mirror adjustment mechanism in the second embodiment;

FIG. 13 is a front view showing the convex mirror adjustment mechanism in the second embodiment;

FIG. 14 is a plane view showing the convex mirror adjustment mechanism in the second embodiment;

FIG. 15 is a right side view showing the convex mirror adjustment mechanism in the second embodiment;

FIGS. 16A and 16B are a flowcharts for explaining the adjustment method for the projection optical system in the second embodiment of the present invention;

FIG. 17A is a schematic view showing a projection optical system of a third embodiment having an optical path length adjustment mechanism (in the state with a short optical path length setting);

FIG. 17B is a schematic view showing the projection optical system of the third embodiment having an optical path length adjustment mechanism (in the state with a long optical path length setting);

FIG. 18 is an exploded perspective view showing a chart holding member and a lower pedestal component in a fourth embodiment of the present invention;

FIG. 19 is a front view showing a transparent plate with a chart formed thereon in the fourth embodiment of the present invention;

FIG. 20 is a front view showing a mirror holder for a convex mirror (second mirror) in a fifth embodiment;

FIG. 21 is a perspective view showing the mirror holder for the convex mirror (second mirror) in the fifth embodiment;

FIG. 22 is a exploded perspective view showing the mirror holder for the convex mirror (second mirror) in the fifth embodiment of the present invention;

FIG. 23 is a schematic view showing an optical structure of a collimator;

FIG. 24 is a schematic view showing an example of a chart image;

FIG. 25 is a perspective view showing a focus adjustment mechanism in a sixth embodiment;

FIG. 26 is a exploded perspective view showing the focus adjustment mechanism in the sixth embodiment;

FIG. 27 is a side view showing the focus adjustment mechanism in the sixth embodiment; and

FIG. 28 is a schematic view showing a portion XXVIII viewed in a direction of an arrow B.

### DETAILED DESCRIPTION OF THE PREFERRED EMBODIMENTS

### First Embodiment

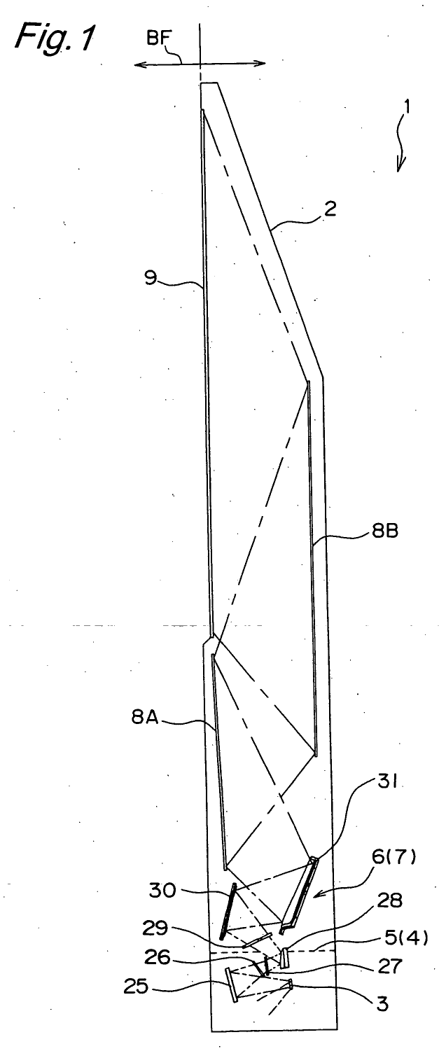

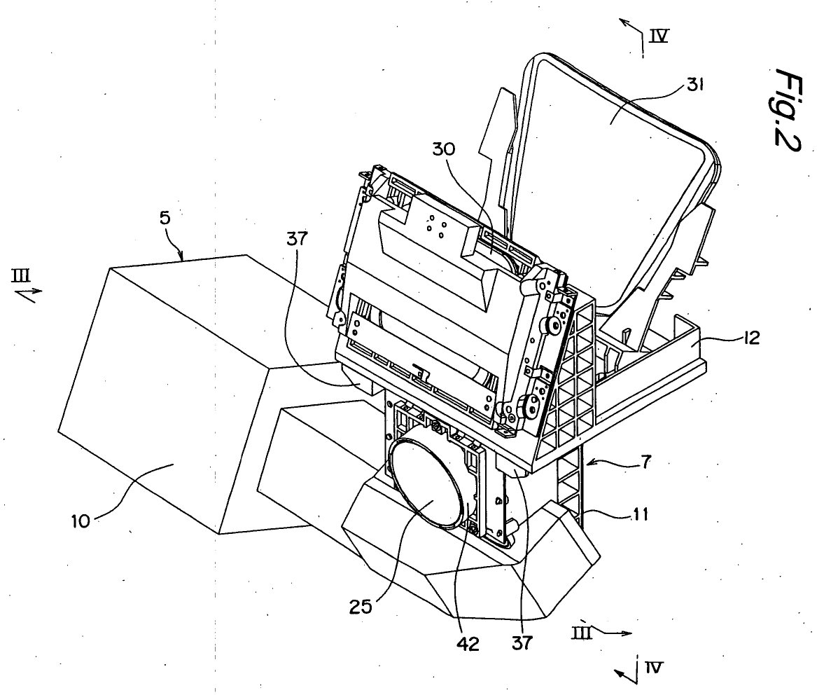

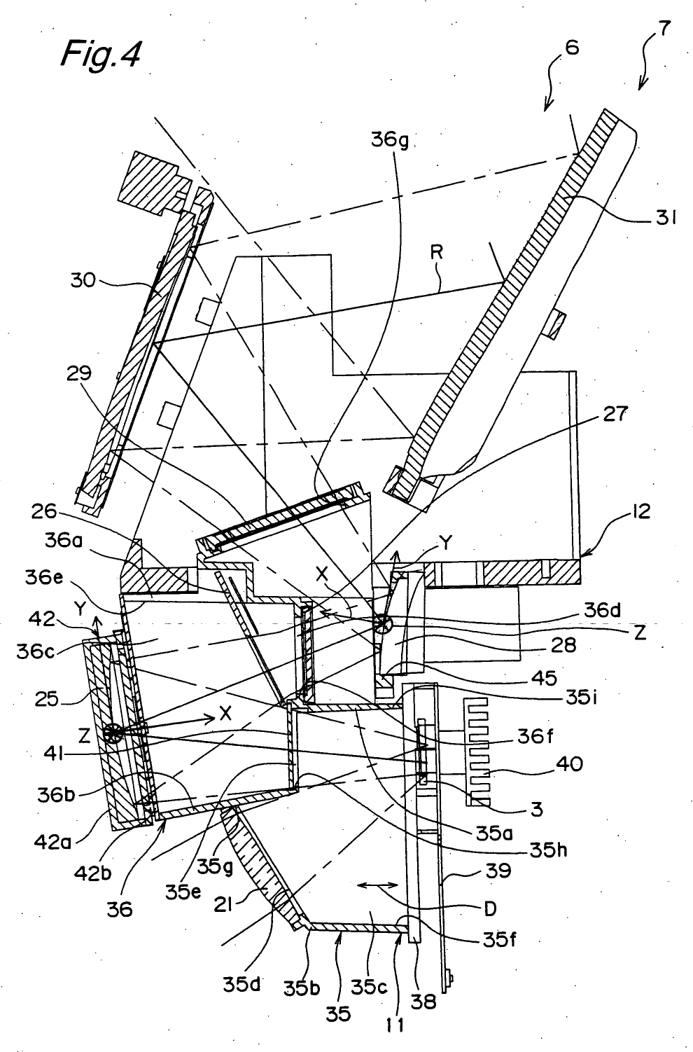

FIG. 1 shows a rear projection television (rear projection TV) 1 which is an embodiment of a projection-type image display apparatus of the present invention. Accommodated within the casing 2 of the rear projection TV 1 are a digital micromirror device (DMD) 3 which is one example of a reflection-type image formation device, an illumination optical system unit 5 having an illumination optical system 4 which irradiates the DMD 3 with illumination light, and a projection optical system unit 7 having a projection optical system 6 which enlarges and projects projection light reflected by the DMD 3, i.e., image light. Arranged on an upper front of the casing 2 is positioned a screen 9, onto which the image enlarged by the projection optical system 6 is projected through two planar mirrors 8A and 8B. Further referring to FIG. 2, in addition to a housing 10 of the illumination optical system unit 5, the casing 2, at a bottom portion, accommodates a lower pedestal component 11 and an upper pedestal component 12 (pedestals) of the projection optical system unit 7. Within the housing 10, optical devices of the illumination optical system 4 are held. The DMD 3 and the optical components of the projection optical system 6 are held by the lower and upper pedestal portions 11, 12. Referring to FIG. 4 through FIG. 6, the lower pedestal component 11 has a pair of platforms 37 at upper portion. The upper pedestal portion 12 is placed on these platforms 37.

The DMD 3 comprises numerous minute mirror elements arranged in two dimensions to form a mirror surface. A reflection angle of each mirror elements can be switched between two directions independently. Each mirror element corresponds to one pixel of the image projected onto the screen 9. Mirror elements the reflection angle of which is set in one of the two directions are in an “on” status. Illumination fluxes from the illumination optical system 4 reflected by these on-status mirror elements (image light) is projected onto the screen 9 through the projection optical system 6 and the planar mirrors 8A, 8B. On the other hand, mirror elements the reflection angle of which is set in the other of the two directions are in the “off” status. The Luminous fluxes from the illumination optical system 4 reflected by these off-status mirror elements are not incident on the projection optical system 6, resulting in that the corresponding pixels on the screen 9 are displayed as black pixels.

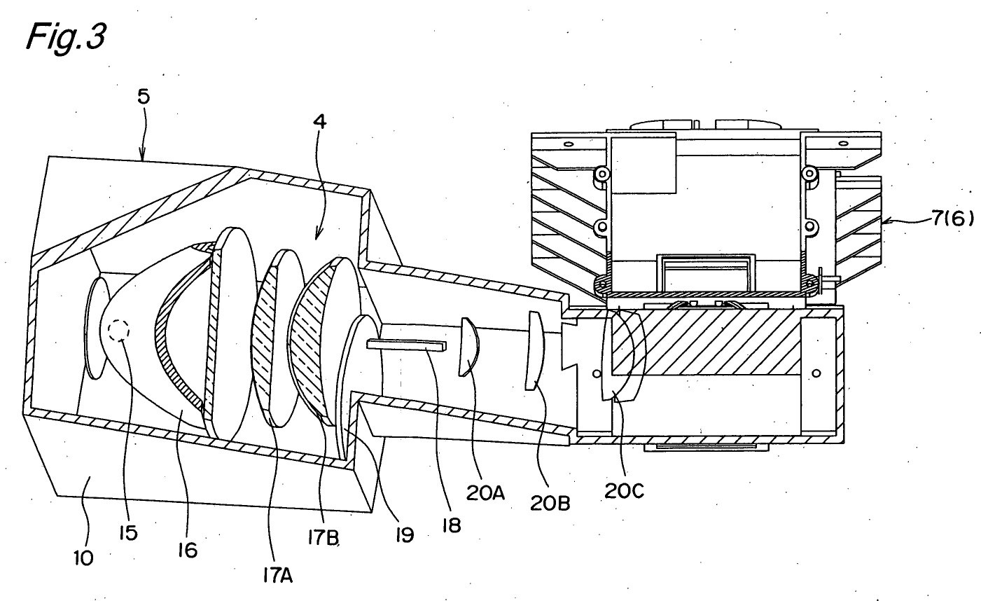

Referring to FIG. 3, the illumination optical system 4 is provided so as to be directed substantially perpendicular to the projection optical system 6. The illumination optical system 4 has, for example, a discharge lamp 15 which is an ultra-high pressure mercury lamp, a parabolic mirror 16, condenser lenses 17A, 17B, a color wheel 19, an integrator rod 18, relay lenses 20A, 20B, and 20C, and an aperture and mirrors not shown. Further, the illumination optical system 4 has an entrance lens 21 shown in FIG. 4.

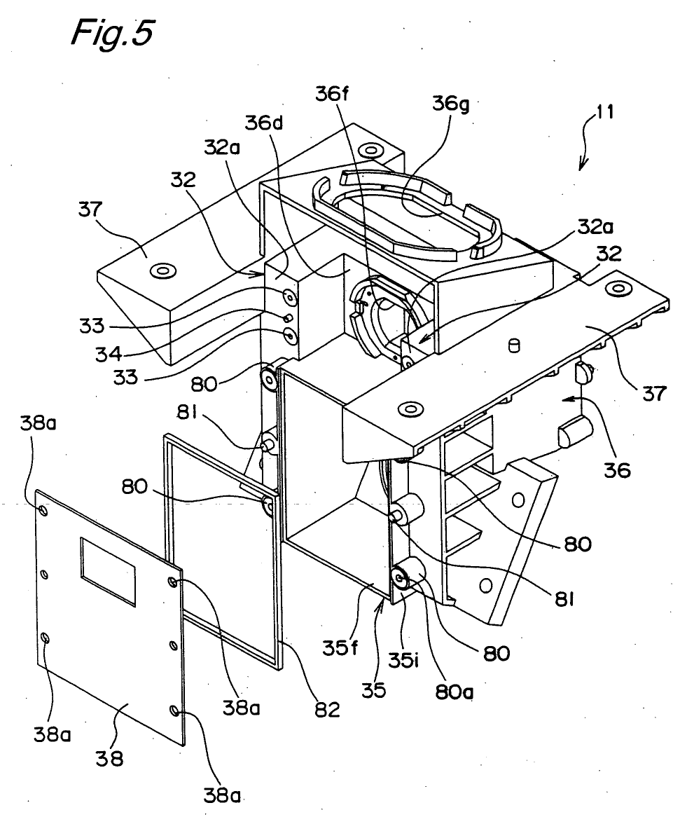

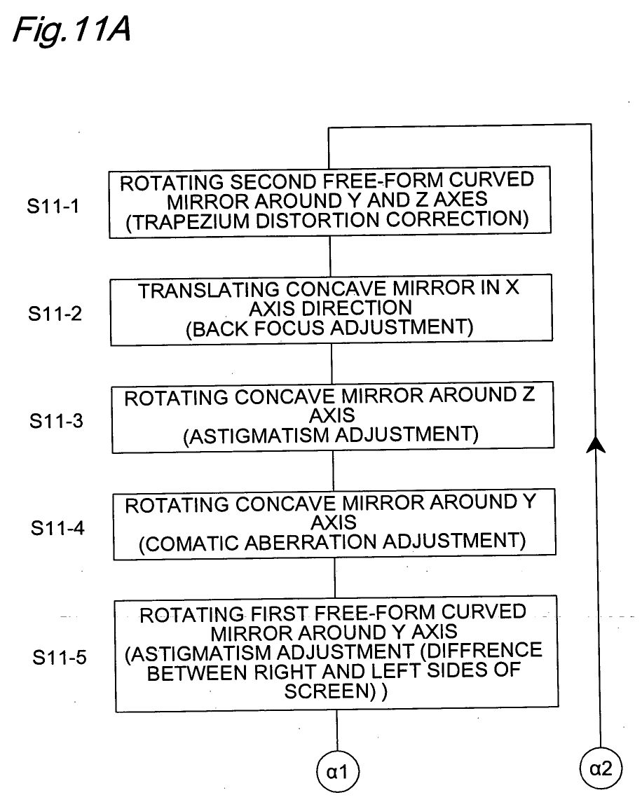

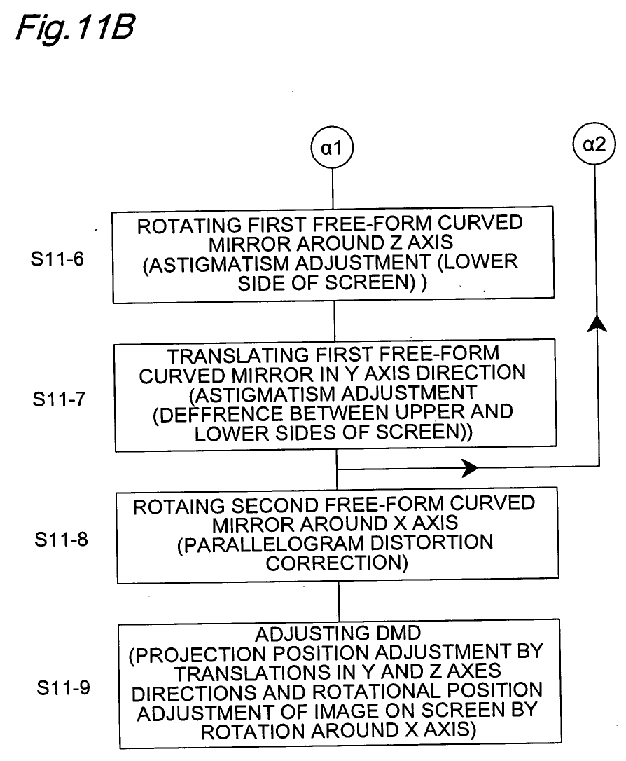

Light emitted from the discharge lamp 15 is converted into parallel rays by the parabolic mirror 16, and is focused on an incidence surface of the integrator rod 18 by the condenser lenses 17A and 17B. Color filters each of which passes red, blue, and green lights respectively are provided on a circumference of the color wheel 19 positioned in proximity to the incidence surface of the integrator rod 18. By rotating the color wheel 19, the light incident on the integrator rod 18 is allocated among different colors by time division. The integrator rod 18 is a rectangular parallelepiped glass rod. The light incident on an internal surface of the integrator rod 18 undergoes total reflection and super positioning, so that an luminous flux having uniform intensity distribution is emitted from an emission surface. The relay lenses 20A to 20C, aperture diaphragm not shown, mirrors not shown, and entrance lens 21 of FIGS. 5 and 11, cause the image of the emission surface of the integrator rod 18 to be formed on the DMD 3. This achieves that the DMD 3 is illuminated with light of uniform intensity.

Referring to FIGS. 1 and 11, the projection optical system 6 has four curved mirrors 25, 28, 30, and 31, two aberration correction plates 27, 29; and one variable aperture diaphragm mechanism 26. In detail, a concave mirror (first curved mirror) 25, the aperture variable diaphragm mechanism 26, a first aberration correction plate 27, a convex mirror (second curved mirror) 28, a second aberration correction plate 29, a first free-form curved mirror (third curved mirror) 30; and a second free-form curved mirror (fourth curved mirror) 31 is disposed in a light path from the DMD 3 to the screen 9. The image light from the DMD 3 is guided to the screen 9 in this order. The concave mirror 25 is a spherical surface mirror, whereas the convex mirror 28 is an axially symmetric aspherical surface mirror. Each of the first and second free-form curved mirrors 30 and 31 has a non-rotationally symmetric reflection surface. The first free-form curved mirror 30 is a concave mirror, whereas the second free-form curved mirror 31 is a convex mirror. The first and second aberration correction plates 27, 29 have almost no optical power. The first and second free-form curved mirrors 30, 31 and the first and second aberration correction plates 27, 29 are made of resin material. Of these optical components constituting the projection optical system 6, the concave mirror 25, variable diaphragm mechanism 26, first aberration correction plate 27, convex mirror 28, and second aberration correction plate 29 are held by the lower pedestal component 11, while the first and second free-form curved mirrors 30, 31 are held by the upper pedestal portion 12.

In the description below, local orthogonal coordinate systems for the respective curved mirrors 25, 28, 30, 31 of the projection optical system 6 will be defined. Specifically, first, a light beam passing an optical path traveling through a center of the DMD 3 and a center of the aperture of the projection optical system 6 to a center of the screen 9 is defined as a reference light beam R (see FIG. 4). Further, normal directions of the mirror faces at the intersections between the reference light beam R and the mirrors are defined as X axes. Then, axes parallel to the incidence planes of the reference light beam R to the mirrors and perpendicular to the X axes are defined as a Y axes. Furthermore, axes perpendicular to the X axes and the Y axes are defined as a Z axes. FIG. 4 shows the X axis, Y axis, and Z axis for the concave mirror 25 as well as the X axis, Y axis, and Z axis for the convex mirror 28.

Then, referring to FIG. 4 and FIG. 5, the lower pedestal component 11 and optical components held thereby will be described in detail. The lower pedestal component 11 is a single member, and comprises a first tubular portion 35 and second tubular portion 36 both of which extends generally in a horizontal direction. The second tubular portion 36 is formed so as to be continuous with the first tubular portion 35, and is positioned upper left side in FIG. 4 with respect to the first tubular portion 35.

As shown in FIG. 4, the first tubular portion 35 comprises a top wall 35a, bottom wall 35b, a pair of side walls 35c opposite to each other, a lower end wall 35d which closes the lower portion of one end (on the left side in FIG. 4), and an upper end wall 35e which closes the upper portion of one end. Further, an opening 35f is formed at the other end (on the right side in FIG. 4) of the first tubular portion 35. On the other hand, the second tubular portion 36 comprises a top wall 36a, bottom wall 36b, a pair of side walls 36c opposite to each other, and an end wall 36d which closes the upper portion of one end (on the right side in FIG. 4). Further, an opening 36e is formed at the other end (on the left side in FIG. 4) of the second tubular portion 26. The platforms 37 described above are provided on an upper outside of the second tubular portion 36. The bottom wall 36b of the second tubular portion 36 protrudes slightly into the first tubular portion 35, and therebelow the lower end wall 35d of the first tubular portion 35 is arranged, while thereabove the upper end wall 35e of the first tubular portion 35 is arranged. On the other hand, the upper end wall 35e of the first tubular portion 35 reaches the end wall 36d of the second tubular portion 36.

The opening 35f of the first tubular portion 35 on the right side in FIG. 4 is closed in the sealed status by the image formation device holding plate (image formation device holder) 38 for holding the DMD 3. The rear side of the DMD 3 is mounted on the base 39. Further, a heat sink (heat dissipation member) 40 is connected to the DMD 3. An orthogonal coordinate system of the DMD 3 will also be defined. Specifically, an axis in the direction of a normal to an image formation surface of the DMD 3 is defined as an X axis, an axis in the short side direction of the image formation surface (almost equivalent to the depth direction in FIG. 4) is defined as a Y axis, and an axis in the longitudinal direction of the image formation surface (almost equivalent to the vertical direction in FIG. 4) is defined as a Z axis. In the present embodiment, the DMD 3 is mounted on the image formation device holding plate 38 in such a way as to allow parallel movements or translations in the Y axis direction, translations in the Z axis direction and rotations around the X axis direction. Therefore, for the position and the inclination of the DMD 3, three axes, that is, the parallel movement in the Y axis direction, the parallel movement in the Z axis direction and the rotation around the X axis direction are adjustable.

The mounting structure of the image formation device holding plate 38 to the first tubular portion 35 is explained with reference to FIG. 5. There are two screw portions each on the right and left sides of the edge (first edge) 35i surrounding the opening 35f of the first tubular portion 35 for a total of four screw portions 80, as well as one positioning protrusion each on the right and left of the edge 35i for a total of two positioning protrusions 81. The screw portions 80 are provided at positions corresponding to four corners of the opening 35f. Further, a female screw 80a is provided in each of the screw portions 80. Six through holes 38a are formed in the image formation device holding plate 38 at positions corresponding to the positioning protrusions 81 and the female screws 80a of the screw portions 80. The positioning protrusions 81 are inserted into the through holes 38a, and moreover male screws passing through the through holes 38a are screwed into the female screws 80a of the screw portions 80 to fix the image formation device holding plate 38 to the first tubular portion 35. Moreover, an elastic member 82 with a strip-frame shape is disposed in a compressed status between the image formation device holding plate 38 and the edge 35i surrounding the opening 35f. The image formation device holding plate 38 is in close contact with the edge 35i via the elastic member 82. With this mounting structure, the image formation device holding plate 38 is mounted on the lower pedestal component 11 with high accuracy. More precisely, the image formation device holding plate 38 is mounted on the lower pedestal component 11 in such a way that an inclination between a top end face of the periphery 35i serving as a mounting reference plane for mounting the image formation device holding plate 38 on the lower pedestal component 11 and the mirror face (image formation surface) of the DMD 3 is not more than ⅙ degree (10 minutes).

An opening 35g is also formed in the lower end wall 35d of the first tubular portion 35 provided in the lower left portion of the lower pedestal component 11 in FIG. 4. An entrance lens 21 of the illumination optical system 4 is mounted on this opening 35g.

An opening 35h opened to the interior of the first tubular portion 35 and to the interior of the second tubular portion 36 is formed in the upper end wall 35e of the first tubular portion 35 positioned on the right side in FIG. 4. The optical path from the DMD 3 to the concave mirror 25 which is the initial optical component of the projection optical system 6 passes through this opening 35h. This opening 35h is closed by dust-proof cover glass 41.

The concave mirror 25 is mounted on the opening 36e of the second tubular portion 36. Specifically, the concave mirror 25 is fixed in place by a mirror holding component (mirror adjustment mechanism) 42, and the opening 36e is closed in a sealed status by the mirror holding component 42. In the present embodiment, the mirror holding component 42 holds the concave mirror 25 onto the lower pedestal component 11 in such a way as to allow translations along the X axis, rotations around the Y axis and rotations around the Z axis. The structure of the mirror holding component 42 will be described later in detail.

The variable aperture diaphragm mechanism 26 is placed within the second tubular portion 36. An opening 36f is also formed in the end wall 36d of the second tubular portion 36, and the first aberration correction plate 27 is mounted in the opening 36f.

The convex mirror 28 is mounted on the second tubular portion 36 outside of the first aberration correction plate 27 of the second tubular portion 36. As shown in FIG. 5, the lower pedestal component 11 comprises a pair of mounting portions 32, protruding outward from both left and right sides of the opening 36f. Mounting surfaces 32a at the tips of the mounting portions 32 are parallel to the openings 35f and 36h, and are formed on the same side (the right side of the lower pedestal component 11 in FIG. 4) as the edge 35i on which is mounted the DMD 3. Further, two screw portions 33 and one positioning protrusion 34 are provided on each of the mounting surfaces 32a. The convex mirror 28 is fixed to the mirror holding component 45. The mirror holding component 45 is fixed onto the mounting surfaces 32a by screwing screws into the screw portions 33. In the present embodiment, the mirror holding component 45 for the convex mirror 28 is fixed onto the lower pedestal component 11 so as to prevent translations along the X axis, Y axis, and the Z axis as well as rotations around the X axis, Y axis, and Z axis. In other words, there is no mechanism to adjust the position and the inclination of the convex mirror 28.

The mounting surfaces 32a for the mirror holding component 45 and the edge 35i onto which the DMD 3 is mounted are provided on the same side of the lower pedestal component 11. This achieves that, in a manufacturing process of the lower pedestal component 11, the mounting surfaces 32a and the edge 35i can be formed simultaneously using the same die. Consequently the positional relationship between the mounting surfaces 32a and the edge 35i can be highly precise, and the convex mirror 28 can be positioned precisely with respect to the DMD 3.

The second aberration correction plate 29 is mounted in the opening 36g formed on the upward outer side of the second tubular portion 36.

As described before, the first and second free-form curved mirrors 30 and 31 are mounted on the upper pedestal component 12. In the present embodiment, the first free-form curved mirror 30 is mounted on the upper pedestal component 12 in such a way as to allow translations in the X axis direction, translations in the Y axis direction, rotations around the Y axis, and rotations around the Z axis. Moreover, the second free-form curved mirror 31 is mounted on the upper pedestal component 12 in such a way as to allow rotations around the X axis, rotations around the Y axis, and rotations around the Z axis. It is to be noted that the rotation of the second free-form curved mirror 31 around the Y axis is rotation on the plane of the upper pedestal component 12 (the plane parallel to the normal and a longitudinal side of the DMD 3). This is because the mirror face of the second free-form curved mirror 31 is almost perpendicular to the plane of the pedestal and because due to a very small rotation angle, the optical adjustment effect is substantially the same whether the second free-form curved mirror 31 is rotated strictly around the Y axis or around the plane of the upper pedestal component 12.

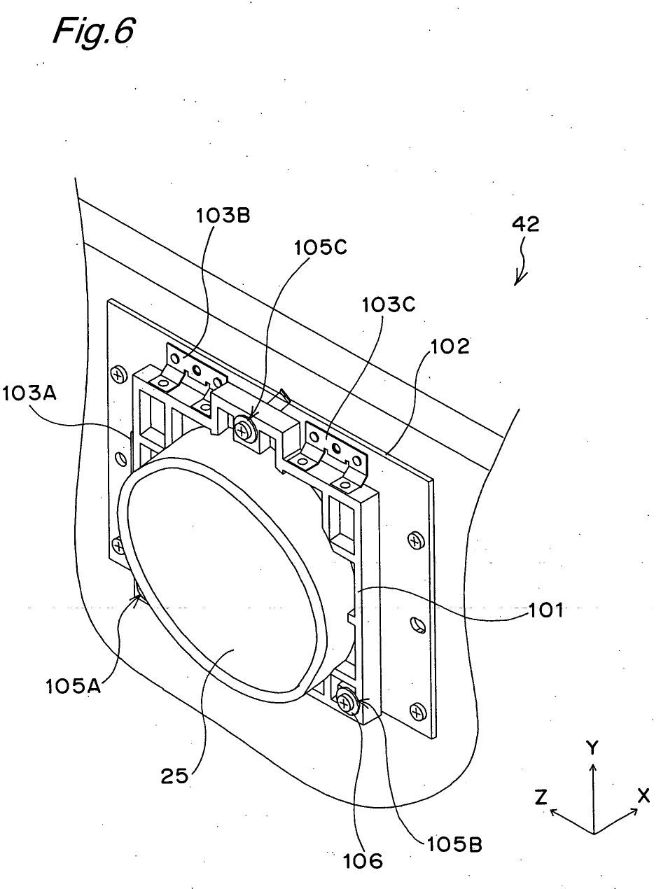

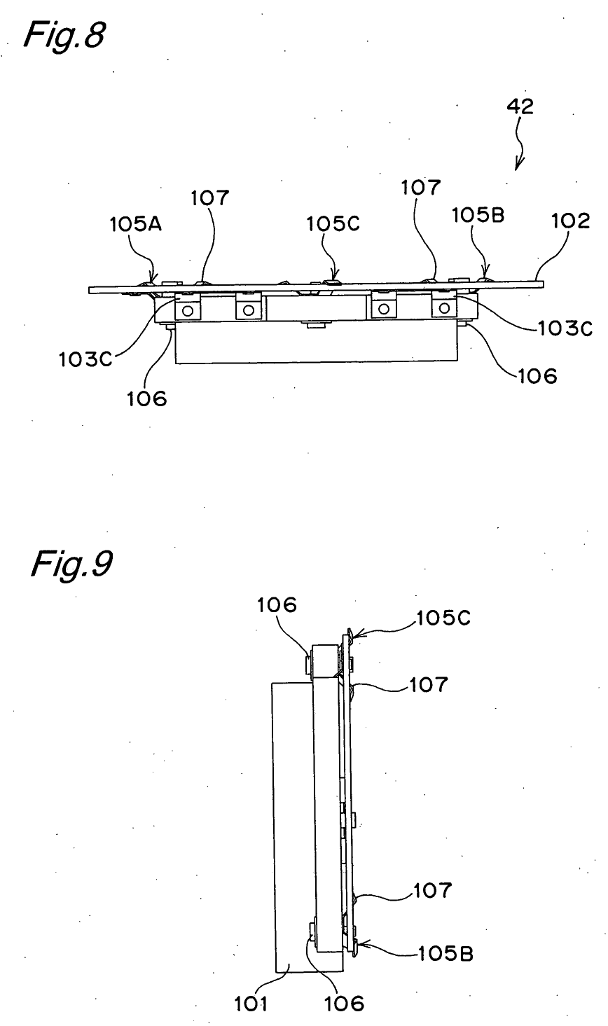

Description is now given of the mirror holding component 42 of the concave mirror 25. With reference to FIGS. 6 to 9, the mirror holding component 42 has a mirror holder 101 for holding the concave mirror 25 and a mirror holder base 102 screwed onto the lower pedestal component 11 Two bosses (not shown) formed on a back surface side of the mirror holder 101 and protruding in the X axis direction are respectively inserted into two positioning holes (not shown) formed on the mirror holder base 102. The mirror holder 101 is elastically urged or biased in the Z axis direction by one holding spring 103A and is elastically urged in the Y axis direction by two holding springs 103B, 103C. With this arrangement, the mirror holder 101 is held onto the mirror holder base 102 so as to be positioned in such a way that the mirror holder 101 can be translated in the X axis direction but cannot be translated in the Y axis direction nor the Z axis direction. The bosses, the positioning holes, and the holding springs 103A to 103C constitute a holder holing means in the third aspect of the present invention.

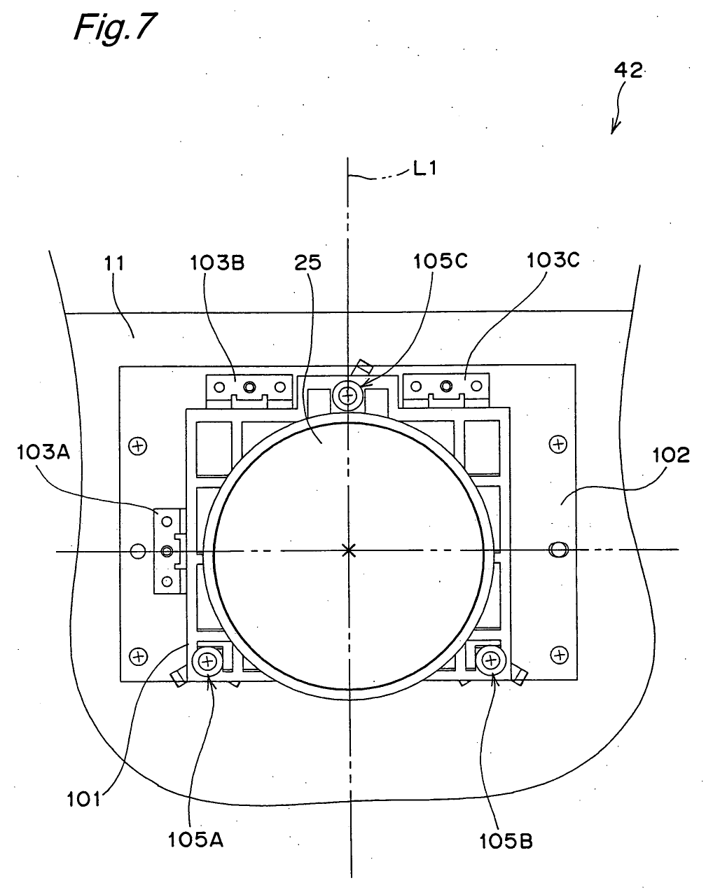

Three fixing mechanisms 105A to 105B are provided for fixing the mirror holder 101 with respect to the mirror holder base 102 in such a way as to allow positioning in the X axis direction. Two fixing mechanisms 105A, 105B are placed below the mirror holder 101 and the mirror holder base 102, while the remaining one fixing mechanism 105C is placed above the mirror holder 101 and the mirror holder base 102. As shown in FIG. 7, the fixing mechanisms 105A and 105B are placed at positions symmetrical to each other with respect to a symmetric axis L1 passing through the center C of the concave mirror 25 and parallel to the Y axis. The fixing mechanisms 105A and 105B are placed at positions symmetrical to the fixing mechanism 105C with respect to a symmetric axis L2 passing through the center C of the concave mirror 25 and parallel to the Z axis. The fixing mechanisms 105A to 105C constitute a positioning means in the first axis direction in the third embodiment of the present invention.

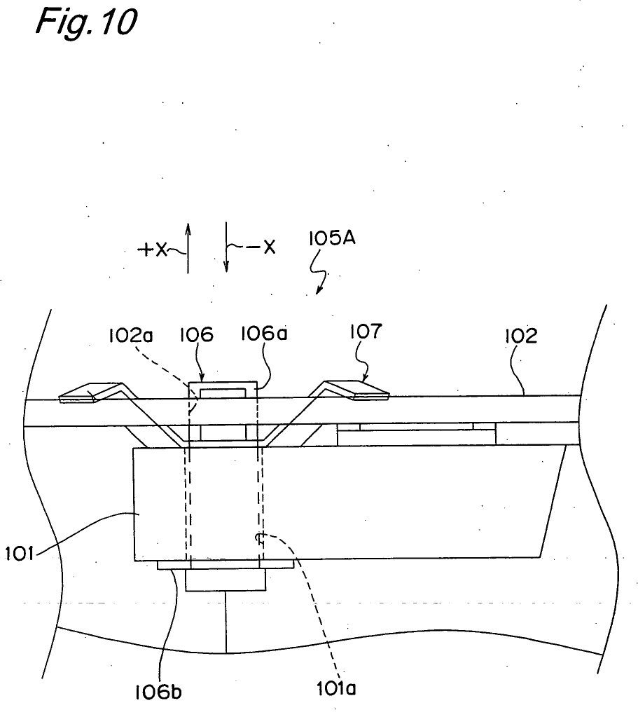

Also with reference to FIG. 10, the fixing mechanism 105A has a screw 106 and a coned disc-type spring 107. A shaft section 106a of the screw 106 is loosely inserted into an X-directional through hole 101a formed on the mirror holder 101 and is fitted with an X-directional screw hole 102a formed on the mirror holder base 102. A head section 106b of the screw 106 is positioned on the front side of the mirror holder 101. The spring 107 elastically urges the mirror holder 101 in the direction away from the mirror holder base 102. With this biasing force, the mirror holder 101 is pressed to the head section 106b of the screw 106, and as a consequence, the mirror holder 101 is fixed to the mirror holder base 102. When the screw 106 is rotated in the direction of tightening the screw 106 into the screw hole 102a, the mirror holder 101 moves in the direction close to the mirror holder base 102 by an amount proportional to the rotation amount of the screw 106 as shown by an arrow +X, and the mirror holder 101 is positioned there. When the screw 106 is rotated in the direction of loosening the screw 106 from the screw hole 102a, the mirror holder 101 moves in the direction away from the mirror holder base 102 by an amount proportional to the rotation amount of the screw 106 as shown by an arrow −X, and is positioned there. The structure of the fixing mechanisms 105B and 105C is identical to that of the fixing mechanism 105A.

As described hereinbefore, the concave mirror 25 can be parallely moved along the X axis direction, rotated around the Y axis and rotated around the Z axis with respect to the lower pedestal component 11.

In the case where the concave mirror 25 is parallely moved in the X axis direction, three screws 106 of the three fixing mechanisms 105A to 105B are rotated in the same direction by the same amount. As a result, the entire mirror holder 101 goes close to or away from the mirror holder base 102 by an amount proportional to the rotation amount of the screw 106, and therefore the concave mirror 25 parallely moves in the X axis direction while maintaining an inclination toward the X axis, the Y axis and the Z axis.

In the case where the concave mirror 25 is rotated around the Y axis, the screw 106 of the fixing mechanism 105A is rotated in the tightening direction or the loosening direction by a certain amount, and the screw 106 of the fixing mechanism 105B is rotated in the opposite direction by the same amount. It is to be noted that the screw 106 of the fixing mechanism 105C is not rotated. By rotating the screws 106 of the fixing mechanisms 105A and 105B in this way, a left-side portion of the mirror holder 101 with respect to the symmetric axis L1 in FIG. 7 comes close to or away from the mirror holder base 102, while a right-side portion with respect to the symmetric axis L1 is displaced from the mirror holder base 102 in the direction opposite to the left-side portion. As a result, the concave mirror 25 held by the mirror holder base 102 rotates around the Y axis (symmetric axis L1).

Further, in the case where the concave mirror 25 is rotated around the Z axis, the screw 106 of the fixing mechanism 105C is rotated in the tightening direction or the loosening direction by a certain amount. The screws 106 of the fixing mechanisms 105A and 105B are rotated in the opposite direction by the same amount. By rotating the screws 106 of the fixing mechanisms 105A to 105C in this way, a lower-side portion of the mirror holder 101 with respect to the symmetric axis L2 in FIG. 7 comes close to or away from the mirror holder base 102, while an upper-side portion with respect to the symmetric axis L2 is displaced from the mirror holder base 102 in the direction opposite to the lower-side portion. As a result, the concave mirror 25 held by the mirror holder base 102 rotates around the Z axis (symmetric axis L2).

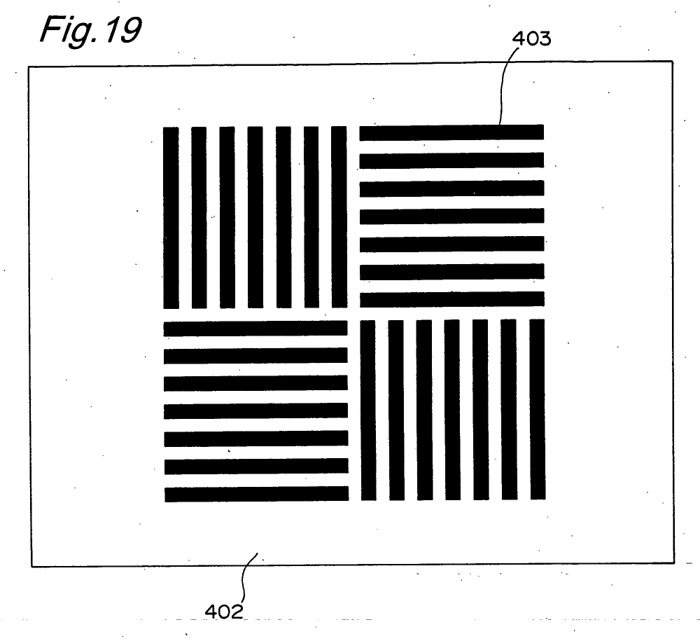

Description is now given of a manufacturing method for the projection optical system 6. The manufacturing method includes steps or procedures for attaching optical components, i.e. four curved mirrors 25, 28, 30, and 31, two aberration correction plates 27 and 29, and one variable aperture diaphragm mechanism 26. The manufacturing method further includes subsequent steps or procedures for adjustment in order to achieve desired optical performance. The steps for adjustment will be described. The mirror elements of the DMD 3 are adjusted so that a chart 403 (see FIG. 19) that is a graphic form or a pattern for adjustment is displayed on the screen 9, and illumination light is applied to the DMD 3 from the illumination optical system 4. With reference to the pattern sent from the DMD 3 and displayed on the screen 9 via the projection optical system 6, adjustment of the projection optical system 6 is performed in the procedures shown in FIG. 11. It is to be noted that the width of a single black or white line in the chart 403 shown in FIG. 19 corresponds to the width of 1 to 3 pixels of the DMD 3. The pattern of the chart 403 may be formed on the entire display area of the DMD or be formed in a plurality of spots necessary for adjustment (e.g., the center of each area in the case of dividing the screen into 9×9 areas).

In this embodiment, among four curved mirrors, the concave mirror 25, the first free-form curved mirror 30 and the second free-form curved mirror 31 are subject to adjustment, whereas the convex mirror 28 is maintained in the state that its position and inclination are fixed and therefore it is not included in the adjustment target. In addition to the curved mirrors of the projection optical system 6, the DMD 3 is also the target of the adjustment.

Adjustment items for every curved mirror are shown below. First, the adjustment of the concave mirror 25 mainly involves parallel movement or translation in the X axis direction for back-focus adjustment, rotation around the Y axis for coma aberration adjustment, and rotation around the Z axis for astigmatism adjustment. The back-focus is, as shown by an arrow “BF” in FIG. 1, a displaced amount of a focus position on an optical path from the screen 9 side to the projection optical system 6 side as shown by an arrow BF in FIG. 1. Then, the adjustment of the first free-form curved mirror 30 involves translation or parallel movement in the Y axis direction, rotation around the Y axis and rotation around the Z axis for astigmatism adjustment. Further, the adjustment of the second free-form curved mirror 31 involves rotation around the Y axis and rotation around the Z axis for keystone (trapezium distortion) correction, as well as rotation around the X axis for parallelogram distortion adjustment as an arbitrary adjustment item.

The adjustment procedures will be described with reference to FIGS. 11A and 11B. First, the second free-form curved mirror 31 is rotated around the Y axis and the Z axis to correct trapezoidal distortion (step S11-1). Next, the concave mirror 25 is translated in the X axis direction for back-focus adjustment (step S11-2). Next, the concave mirror 25 is rotated around the Z axis for astigmatism adjustment (step S11-3). Further, the concave mirror 25 is rotated around the Y axis for comatic aberration adjustment (step S11-4). These trapezoidal distortion correction, back-focus adjustment, astigmatism adjustment and coma aberration adjustment (steps S11-1 to S11-4) are essential items.

With reference to an image of the chart 403 projected onto the screen 9, adjustment of steps S11-5 to S11-7 is performed where necessary. First, the first free-form curved mirror 30 is rotated around the Y axis for adjustment of astigmatism (screen difference between the left and right sides) (step S11-5). Next, the first free-form curved mirror 30 is rotated around the Z axis for adjustment of astigmatism (lower screen) (step S11-6). Next, the first free-form curved mirror 30 is translated in the Y axis direction for adjustment of astigmatism (screen difference between the upper and lower sides) (step S11-7).

Till aberration and distortion are reduced to desired levels, the adjustment of the steps S11-1 to S11-7 is repeated. Moreover, it is preferably that in the step S11-8, the second free-form curved mirror 31 is rotated around the X axis to correct parallelogram distortion.

After the adjustment of the curved mirrors of the projection optical system 6 is finished in the steps S11-1 to S11-8, adjustment of the DMD 3 in step S11-9 is performed. More specifically, the projection position of an image on the screen 9 is adjusted by translation of the DMD 3 in the Y axis direction and translation of the DMD 3 in the Z axis direction. Also by rotation around the X axis, the rotation position of an image on the screen 9 is adjusted.

Description is given of the reasons why the projection optical system 6 is adjusted while the position and the inclination of the convex mirror 28 is fixed in the present embodiment. Firstly, since the DMD 3 and the convex mirror 28 are positioned with high positional accuracy due to their mechanical mounting structure on the lower pedestal component 11 as described before, either one of the DMD 3 and the convex mirror 28 can be maintained while its position and inclination is kept to be fixed. Secondly, while the adjustment of the concave mirror 25 and convex mirror 28 placed next thereto mainly relates to imaging performance, the adjustment of the first free-form curved mirror 30 and the second free-form curved mirror 31 mainly relates to geometric aberration. Therefore, the adjustment of the concave mirror 25 and the convex mirror 28 and the adjustment of the first free-form curved mirror 30 and the second free-form curved mirror 31 should preferably be performed separately from each other. However, since the convex mirror 28 is placed closer to the first and second free-form curved mirrors 30, 31 side than the concave mirror 25, changes in position and inclination of the convex mirror 28 pose a large influence on the first and second free-form curved mirrors 30, 31. Consequently, if either one of the concave mirror 25 and the convex mirror 28 is to be adjusted, then the adjustment of the concave mirror 25 is preferable to the adjustment of the convex mirror 28. Because of these first and second reasons, the convex mirror 28 is maintained in the state its position and inclination is fixed and the convex mirror 28 is out of the adjustment target in the adjustment method in the present embodiment.

In the adjustment method for the projection optical system 6 in the present embodiment, three axes for position and the inclination of the concave mirror 25 are adjusted but the position and the inclination of the convex mirror 28 are not adjusted, and so in view of the projection optical system 6 as a whole, the adjustment items or the number of adjustment-target axes is reduced. Therefore, the time necessary for adjustment of the projection optical system 6 can be shortened and desired optical performance can easily be attained. Moreover, since the mechanisms to parallely move or rotate the convex mirror 28 are not necessary, it becomes possible to simplify the structure of the projection optical system 6 and to reduce the number of component parts.

### Second Embodiment

An projection optical system 6 of a rear projection TV 1 that can be manufacture by a manufacturing method for a projection optical system according to a second embodiment of the present invention is different from the first embodiment in the following points. First, a DMD 3 is fixed onto the image forming holding plate 38 in such a way that the DMD 3 does not translated in the X axis, Y axis and Z axis directions nor rotate around the X axis, the Y axis and the Z axis. In other words, there is no mechanism to adjust the position and the inclination of the DMD 3. Moreover, the mirror holding component 45 of a convex mirror 28 is mounted on a lower pedestal component 11 in such a way that the mirror holding component 45 can be translated in the Y axis and Z axis. In other words, the position of the convex mirror 28 is adjustable in the Y axis and Z axis directions. Further, the concave mirror 25 can be translated along the X axis, Y axis and Z axis directions as described hereinbelow. The other aspects of the structure of the projection optical system 6 of the rear projection TV 1 in the present embodiment are identical to those in the first embodiment as shown in FIGS. 1 to 5.

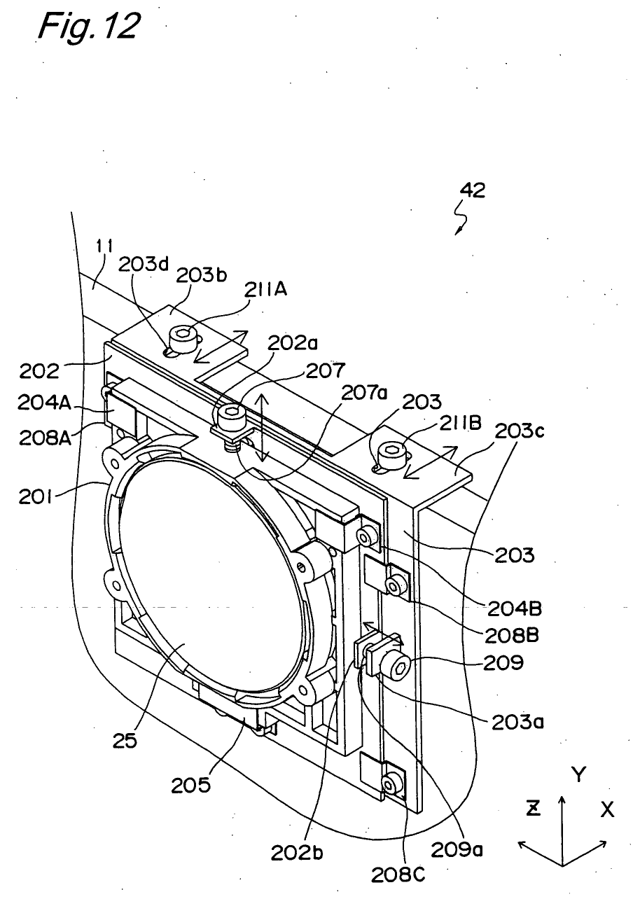

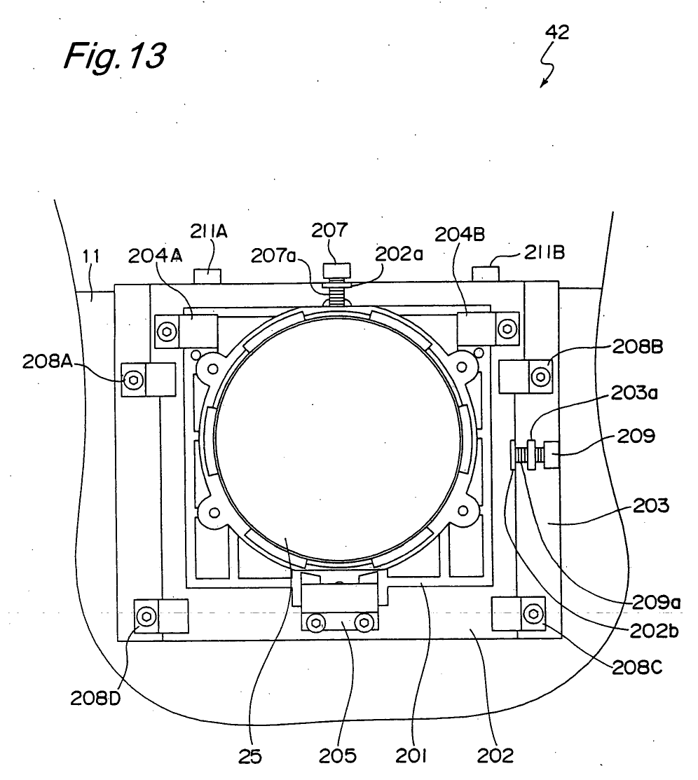

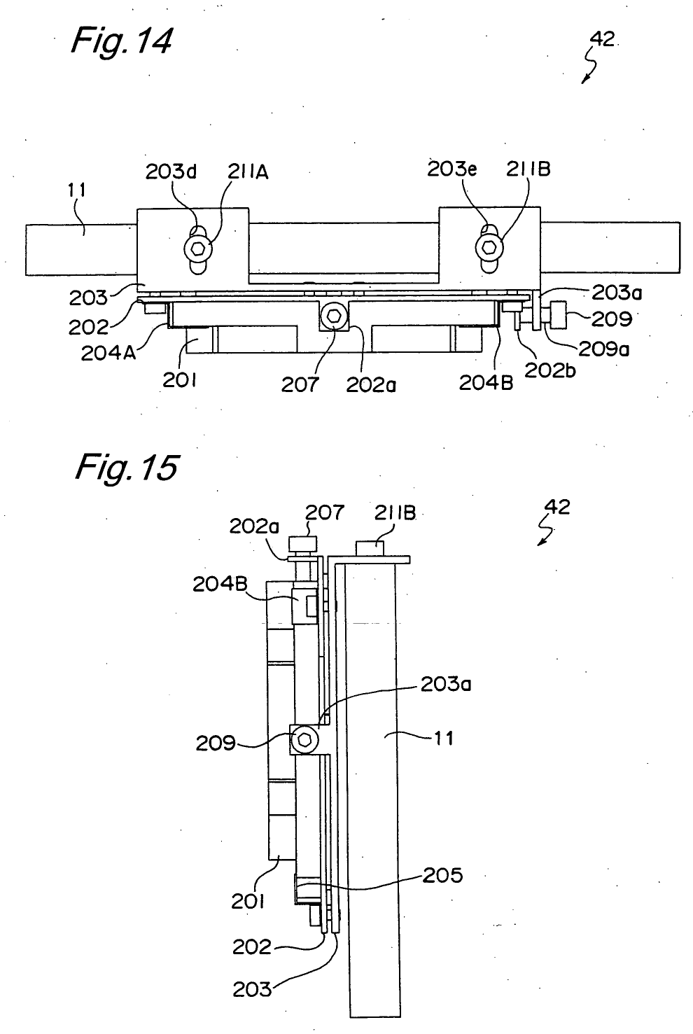

The mirror holding component 42 of the concave mirror 25 in the present embodiment will be described with reference to FIGS. 12 to 15. The mirror holding component 42 has a mirror holder 201 for holding the concave mirror 25, a Z axial adjustment plate (second adjustment plate) 202 and an X axial adjustment plate (first adjustment plate) 203.

The mirror holder 201 is mounted on the Z axial adjustment plate 202 displaceably only in the Y axis direction. Two bosses (not shown) formed on the back surface side of the mirror holder 201 and protruding in the X axis direction are respectively inserted into two long holes (not shown) which are formed on the Z axial adjustment plate 202 and which extend in the Y axis direction. These bosses and the long holes restrict movement of the mirror holder 201 in the Y axis direction. The mirror holder 201 is elastically urged to the Z axial adjustment plate 202 by two holding springs 204A and 204B placed on both left and right sides on the upper side and one pressure bar 205 placed on the lower side, and the back surface side of the mirror holder 201 is constantly in contact with the front surface of the Z axial adjustment plate 202. In other words, movement of the mirror holder 201 in the X axis direction is regulated by the Z axial adjustment plate 202. Proximal ends of the holding springs 204A, 204B, 205 are screwed onto the Z axial adjustment plate 202, while distal front ends thereof are in contact with the front surface of the mirror holder 201.

A screw hole is formed on a tab-like section 202a on the top end of the Z axial adjustment plate 202, and a shaft section 207a of a Y axial adjustment screw 207 is fitted into the screw hole. The shaft section 207a of the Y axial adjustment screw 207 extends in the Y axis direction. Moreover, the top end of the shaft section 207a is fitted into a screw hole formed on the top end of the mirror holder 201. By rotating the Y axial adjustment screw 207 in the screwing direction or the loosening direction, the mirror holder 201 ascends or descends in the Y axis direction by an amount proportional to the rotation amount. Since the concave mirror 25 is held by the mirror holder 201, the concave mirror 25 is displaced in the Y axis direction together with the mirror holder 201.

The Z axial adjustment plate 202 is mounted on the X axial adjustment plate 203 displaceably only in the Z axis direction Two bosses (not shown) formed on the back surface side of the Z axial adjustment plate 202 and protruding in the X axis direction are respectively inserted into two long holes (not shown) which are formed on the X axial adjustment plate 203 and which extend in the Z axis direction. These bosses and the long holes regulate movement of the mirror holder 201 in the Y axis direction. The Z axial adjustment plate 202 is elastically biased to the X axial adjustment plate 203 by four holding springs 208A to 208D positioned at four corners, and the back surface side of the Z axial adjustment plate 202 is constantly in contact with the front surface of the X axial adjustment plate 203. In other words, movement of the Z axial adjustment plate 202 in the X axis direction is regulated by the X axial adjustment plate 203. The starting ends of the holding springs 208A to 208D are screwed onto the X axial adjustment plate 203, while the front ends thereof are in contact with the front surface of the Z axial adjustment plate 202.

A screw hole is formed on a tab-like section 203a on a light lateral section of the X axial adjustment plate 203 in the drawing, and a shaft section 209a of a Z axial adjustment screw 209 is fitted into the screw hole. The shaft section 209a of the Z axial adjustment screw 209 extends in the Z axis direction. Moreover, the top end of the shaft section 209a is fitted into a screw hole formed on a tab-like section 202b in a right lateral section of the Z axial adjustment plate 202 in the drawing By rotating the Z axial adjustment screw 209 in the screwing direction or the loosening direction, the Z axial adjustment plate 202 is displaced leftward or rightward in the Z axis direction in the drawing by an amount proportional to the rotation amount. Since the concave mirror 25 is mounted on the Z axial adjustment plate 202 via the mirror holder 201, the concave mirror 25 is displaced in the Z axis direction together with the Z axial adjustment plate 202.

The X axial adjustment plate 203 is mounted on the lower pedestal component 11 displaceably only in the X axis direction. A pair of tab-like sections 203b and 203c protruding in the X axis direction are provided on the top end of the X axial adjustment plate 203. Long holes 203b, 203e extending in the X axis direction are formed on these tab-like sections 203b and 203c. Screw holes are formed on the lower pedestal component 11 at positions corresponding to the long holes 203b and 203e. Two setscrews 211A, 211B are fitted into screw holes on the lower pedestal component 11 through the long holes 203b, 203e. By screwing the setscrews 211A, 211B, the tab-like sections 203b, 203c of the X axial adjustment plate 203 are fixed to the lower pedestal component 11. By loosening the setscrews 211A, 211B, the X axial adjustment plate 203 can be displaced in the X axis direction along the long holes 203b and 203e. Since the concave mirror 25 is mounted on the X axial adjustment plate 203 via the mirror holder 201 and the Z axial adjustment plate 202, the concave mirror 25 is displaced together with the X axial adjustment plate 203.

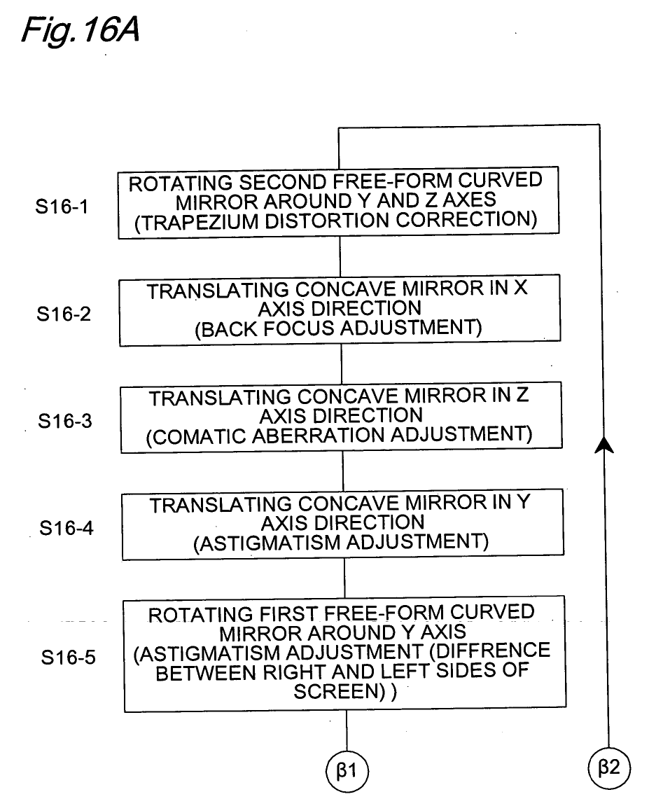

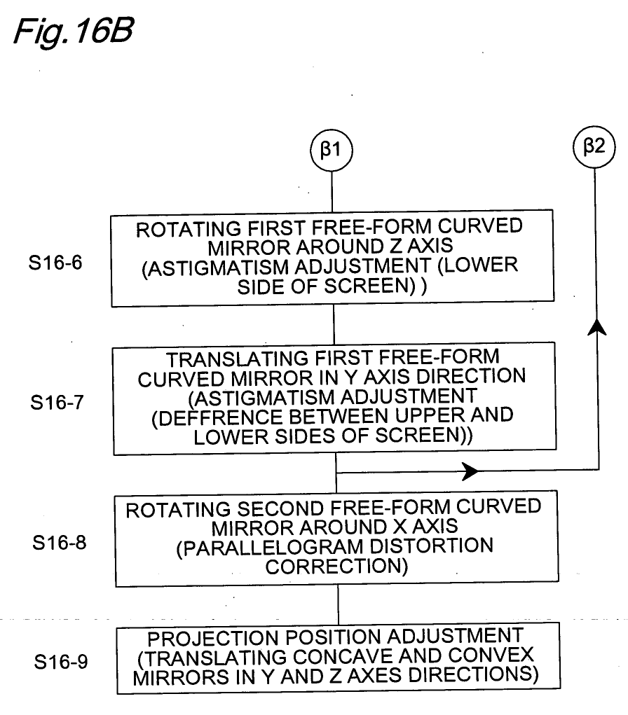

In the present embodiment, the projection optical system 6 is adjusted in the procedures shown in FIGS. 16A and 16B with reference to a chart 403 shown on the screen 9. All the curved mirrors of the projection optical system 6, i.e., the concave mirror 25, the convex mirror 28, the first free-form curved mirror 30 and the second free-form curved mirror 31, are subject to adjustment, whereas the DMD 3 is maintained in the state that its position and inclination are fixed and therefore it is not included in the adjustment target. The adjustment items for every curved mirror are identical to those in the first embodiment.

With reference to FIGS. 16A and 16B, first, the second free-form curved mirror 31 is rotated around the Y axis and the Z axis to correct trapezium distortion (step S16-1). Next, the concave mirror 25 is translated in the X axis direction for back-focus adjustment (step S16-2). Next, the concave mirror 25 is translated in the Z axis direction for comatuc aberration adjustment (step S16-3). Further, the concave mirror 25 is translated in the Y axis direction for astigmatism adjustment (step S16-4). These trapezoidal distortion correction, back-focus adjustment, astigmatism adjustment and coma aberration adjustment (steps S16-1 to S16-4) are essential items.

With reference to an image of the chart 403 projected onto the screen 9, adjustment of steps S16-5 to S16-7 is performed where necessary. First, the first free-form curved mirror 30 is rotated around the Y axis for adjustment of astigmatism (screen difference between the left and right sides) (step S16-5). Next, the first free-form curved mirror 30 is rotated around the Z axis for adjustment of astigmatism (lower side of the screen) (step S16-6). Next, the first free-form curved mirror 30 is translated in the Y axis direction for adjustment of astigmatism (difference between the upper and lower sides of the screen) (step S16-7).

Till aberration and distortion are reduced to desired levels, the adjustments of the steps S16-1 to S16-7 are repeated. Moreover, it is preferably that the second free-form curved mirror 31 is rotated around the X axis to correct parallelogram distortion (step S16-8).

After the adjustment of the curved mirrors of the projection optical system 6 is finished in the steps S16-1 to S16-8, instead of the adjustment of the DMD 3 (see step S11-9 in FIG. 11), the concave mirror 25 and the convex mirror 28 are translated in the Y axis direction and the Z axis direction by the same amount to adjust the projection position of an image on the screen 9.

In the present embodiment, three axes for the position and the inclination of the concave mirror 25 are adjusted but the position and the inclination of the DMD 3 are not adjusted and as for the convex mirror 28, only two axes are adjusted for adjustment of the projection position. Consequently, in view of the projection optical system 6 as a whole, the adjustment items or the number of adjustment-target axes is reduced. Therefore, the time necessary for adjustment of the projection optical system 6 can be shortened and desired optical performance can easily be attained. Moreover, since the mechanisms to parallely move or rotate the DMD 3 are not necessary, it becomes possible to simplify the structure of the projection optical system 6 and to reduce the number of component parts.

### Third Embodiment

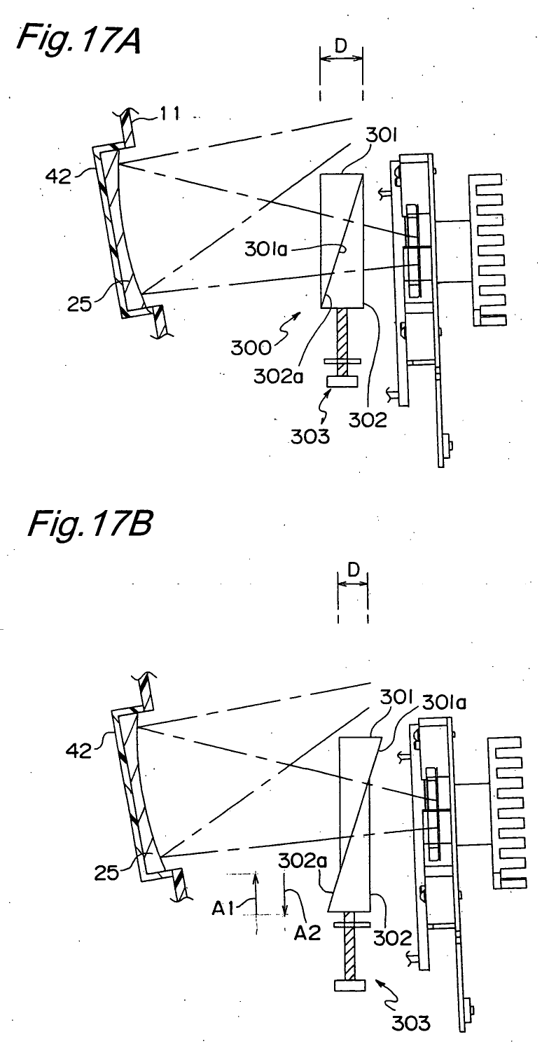

In the projection optical system 6 in the first and second embodiments, an optical path length adjustment mechanism 300 as shown in FIGS. 17A and 17B may be placed between the DMD 3 and the concave mirror 25. The optical path length adjustment mechanism 300 has wedge-type optical elements 301 and 302 which respectively have inclined surfaces 301a and 302a inclined with respect to the normal direction of an image formation surface of the DMD 3 (X axis direction of the DMD 3) and which are made of a material with high translucency. The position and the inclination of one wedge-type optical element 301 are fixed. The other wedge-type optical element 302 can be moved backward from and forward to the wedge-type optical element 301 in the Y axis direction by a screw-type position adjustment mechanism 303 (see arrows A1 and A2 in FIG. 17B). Regardless of the position of the wedge-type optical element 302, the inclined surfaces 301a and 302a of the two wedge-type optical elements 301 and 302 are kept in the state of being in contact with each other.

The more the overlapping amount of the inclined surfaces 301a and 302a of the two wedge-type optical elements 301 and 302 increases, the longer a distance “D” that an optical path going from the DMD 3 to the concave mirror 25 passes the wedge-type optical elements 301 and 302 becomes. The longer distance “D” substantially increases an optical path length from the DMD 3 to the concave mirror 25. In other words, the longer the distance “D” that the optical path passes the wedge-type optical elements 301 and 302 becomes, the more the concave mirror 25 goes away from the DMD 3 in the X axis direction of the DMD 3. Therefore, the optical path length adjustment mechanism 300 can adjust the relative position of the concave mirror 25 with respect to the DMD 3 without changing the position and the inclination of the concave mirror 25.

Even after the adjustment of the position and the inclination of the concave mirror 25 (steps S11-5 to S11-7 in FIGS. 11A and 11B, and steps S16-5 to S16-7 in FIGS. 16A and 16B) is finished, the back-focus adjustment can be achieved by adjusting the X axial position of the concave mirror 25 with the optical path length adjustment mechanism 300 without changing the position and the inclination of the concave mirror 25.

### Fourth Embodiment

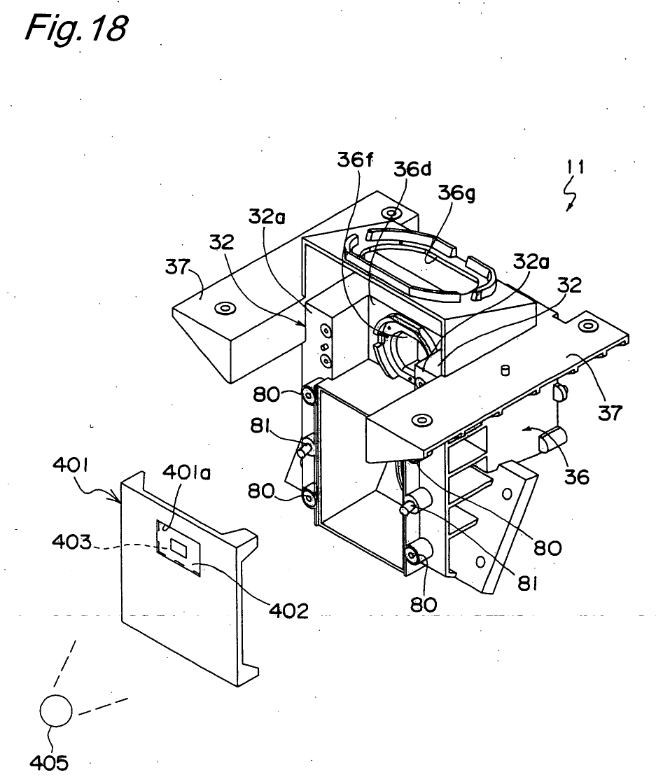

In the first and second embodiments, the projection optical system 6 is adjusted by referring to an image (chart 403) which is formed in the DMD 3 by applying illumination light from the illumination optical system 4 to the DMD 3 and is displayed on the screen 9. However, in the adjustment method in the first embodiment, the procedures prior to the adjustment of the DMD 3 (step S11-9) can be performed before the DMD 3 is mounted on the lower pedestal component 11. Further, in the adjustment method in the second embodiment, the procedures can also be performed before the DMD 3 is mounted on the lower pedestal component 11. Such adjustment of the projection optical system 6 in the state prior to the mounting of the DMD 3 is implemented by using a chart holding member 401 shown in FIG. 18.

The chart holding member 401 can be detachably mounted, in place of the image formation device holding plate 38, on the opening 35f of the first tubular portion 35 in the lower pedestal component 11. A through hole 401a is formed on the chart holding member 401, and a transparent plate 402 is mounted so as to seal the through hole 401a. The through hole 401a is formed at a position corresponding to the DMD 3 held by the image formation device holding plate 38. More precisely, when the chart holding member 401 is mounted on the first cylindrical section 35, the through hole 401a is positioned at a spot where the DMD 3 is to be placed in the case where the image formation device holding plate 38 is mounted on the first tubular portion 35. A chart 403 that is, for example, a graphic form or a pattern for adjustment as shown in FIG. 19 is formed on the transparent plate 402.

After the chart holding member 401 is mounted on the first tubular portion 35, light is applied to the transparent plate 402 from an adjustment light source 405. The light transmitting the transparent plate 402 forms an image corresponding to the chart 403, and the image is projected onto the screen 9 via the projection optical system 6 and the plane mirrors 8A and 8B. By referring to the image of the chart 403 projected onto the screen 9, the projection optical system 6 can be adjusted even before the mounting of the DMD 3 and the illumination optical system 4.

### Fifth Embodiment

As previously described, in the first embodiment, three axes for the position and the inclination of the concave mirror 25 are adjusted, whereas the potion and the inclination of the convex mirror 28 are not adjusted. However, it preferable that the mirror holding component 45 is attached to the lower pedestal component 11 after completion of separate procedures in which the position and the inclination of the convex mirror to the mirror holding component 45 are adjusted.

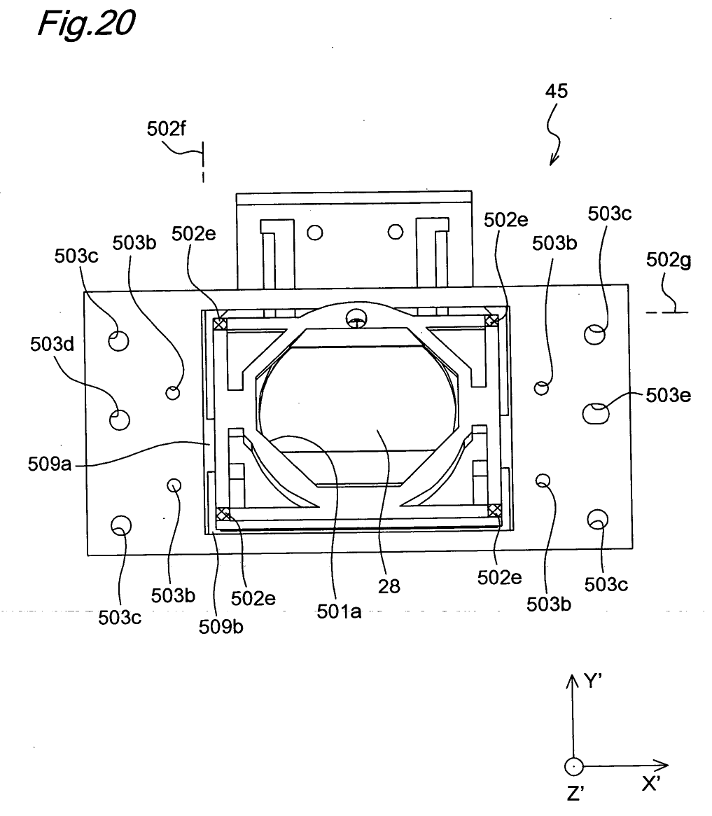

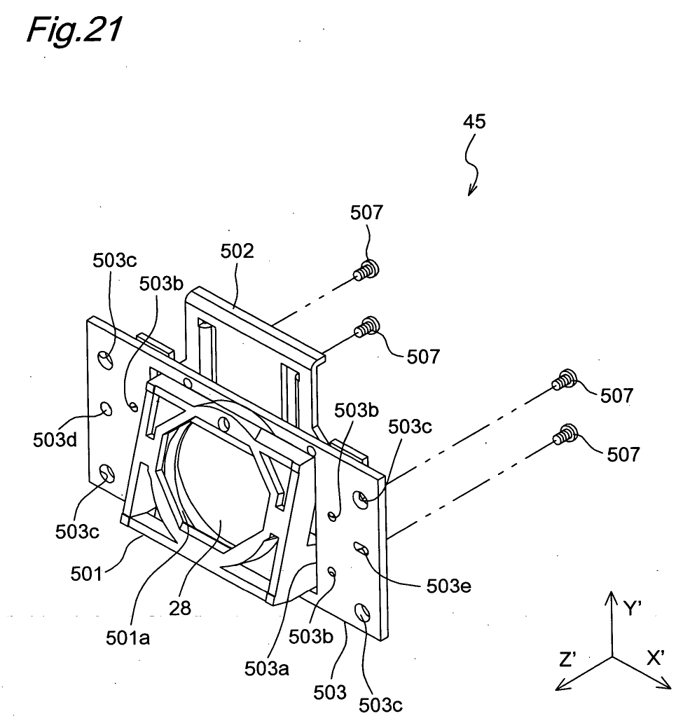

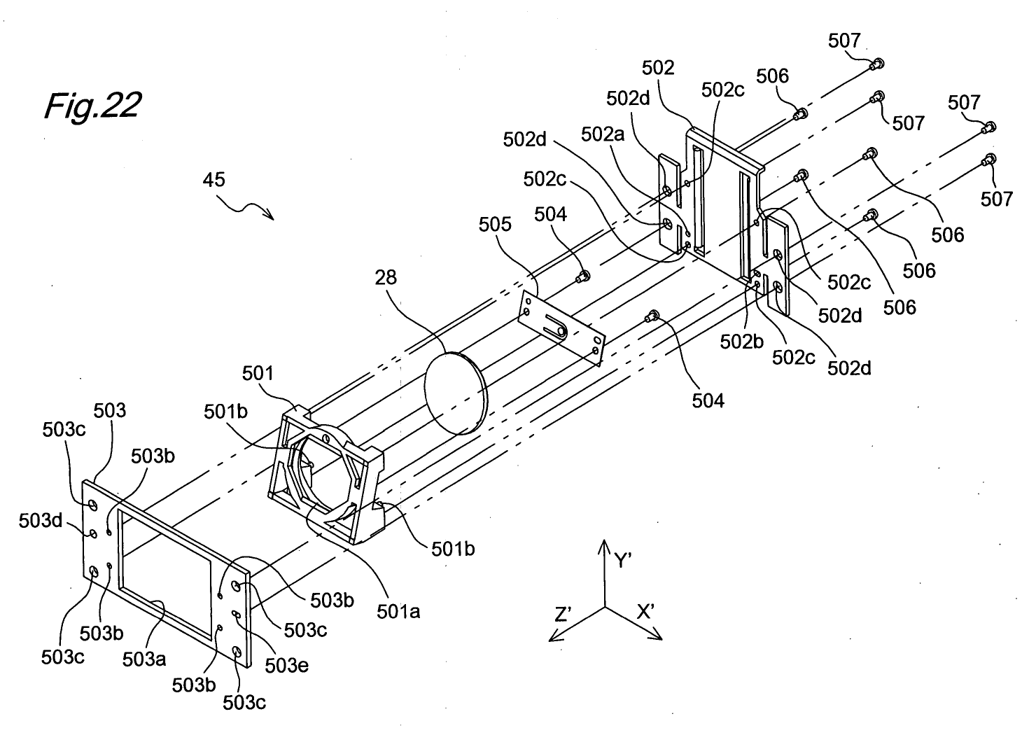

FIGS. 20 to 22 show one example of the mirror holding component 45 having a mechanism for such adjustment. The mirror holding component 45 is provided with, as well as a mirror holder 501, a movable mirror holder base 502 and a fixed mirror holder base 503 respectively having plate-like configurations.

In the description below, local orthogonal coordinate system for the mirror holding component 45 will be defined. Specifically, first, a horizontal direction parallel to a contact surface between the movable mirror holder base 502 and the fixed mirror holder base 503 is defined as an X′ axis. Further, an axis parallel to the contact surface between the movable mirror holder base 502 and the fixed mirror holder base 503 and perpendicular to the X′ axis is defined as a Y′ axis. Furthermore, an axis perpendicular to both the X′ and Y′ axes (a normal direction of the contact surface between the movable mirror holder 502 and the fixed mirror holder 503) is defined as a Z′ axis. The X′, Y′, and Z′ axes are respectively elongated to similar directions of the X, Y, and Z axes defined for the curved mirrors 25, 28, 30, and 31 in the projection optical system 6.

The convex mirror 28 is arranged on a back side of the mirror holder 501. A holding member 505 is fixed to the mirror holder 501 at both ends thereof by two screws 504. The convex mirror 28 is elastically urged to the back side by the holding member 505 to be fixed on the mirror holder 501. The mirror holder 501 is formed with an opening 501a through which a reflection surface of the convex mirror 28 is exposed to a front surface of the mirror holder 501.

The mirror holder is fixed to the movable mirror holder base 502. A pair of positioning bosses 501b are formed on the back side of the mirror holder 501. The positioning bosses 501b are respectively inserted into a positioning circle bore 502a and a positioning long bore 502b, thereby the mirror holder 501 being positioned with respect to the movable mirror holder base 502. Further, on the back side of the mirror holder 501, four screw holes are formed (not shown). The mirror holder base 502 is formed with four through holes 502c at positions corresponding to the screw holes of the mirror holder 501. Screw shafts of four screws 506 are inserted through the through holes 502c form a back side of the movable mirror holder base 502 and fitted into the screw holes of the mirror holder 501. These screws 506 fix the mirror holder 501 to the movable mirror holder base 502.

The movable mirror holder base 502, to which the mirror holder 501 is fixed, is fixed to fixed mirror holder base 503 by four screws 507. The fixed mirror holder base 503 is formed with an opening or a window 503a penetrating the fixed mirror holder base 503 in thickness direction thereof. In the present embodiment, the window 503a has a rectangular shape. The mirror holder 501 is inserted through the window 503a so as to be projected from a front side of the fixed mirror holder base 503. Around the window 503a, the front side of the movable mirror holder base 502 is abutted or contacted with the back side of the fixed mirror holder base 503. The contact area around the window 503a constitutes the contact surface previously mentioned. As most clearly shown in FIG. 20, a size of the window 503a is set such that clearances 509a and 509b in the X′ and Y′ directions are formed between peripherals of the mirror holder 501 and window 503a. The fixed mirror holder base 502 is provided with four screw holes 503b respective two of which are arranged on right and left sides to the window 503a. The above-mentioned screws 507 are fitted into the screw hoes 503b. Further, the movable mirror holder base 502 is formed with four through holes 502d penetrating in a thickness direction thereof respectively at positions corresponding to the screw holes 503b. Sizes of the through holes 502s are larger enough than screw shafts of the screws 507. The screw shafts of the screws 507 are inserted through the through hole 502d and fitted into the screw holes 503b, resulting in that the movable mirror holder base 501 is sandwiched between a screw head of the screw 507 and the fixed mirror holder base 503 so as to be fixed or immobilized.

As described above, the clearances 509a and 509b are provided between the window 503b of the fixed mirror holder base 503 and the mirror holder 501, and the sizes of the through holes 502d of the movable mirror holder base 502 are larger than those of the screw shafts of the screws 507 inserted through the through holes 502d. These arrangements allow displacements and rotations of the movable mirror holder base 502 with respect to the fixed mirror holder base 503 by releasing the screws 507, followed by fixation of the movable mirror holder base 502 at the displaced or rotated position by re-tightening the screws 507. Therefore, three axes for the position and the rotation of the convex mirror 28 with respect to the mirror holding component 45. Specifically, positions in the X′ and Y′ axes direction and an angle around the Z′ axis with respect to the fixed mirror holder base 503 can be adjusted.

The fixed mirror holder base 503 is formed with four through holes 503c through which screws (not shown) for fixation to the lower pedestal component 11 (see FIG. 5) are inserted. Further, the fixed mirror holder base 503 is formed with positioning circle hole 503d and positioning long hole 503e respectively corresponding to bosses for positioning (not shown) of the lower pedestal component 11.

When the mirror holding competent 45 is assembled, the fixed mirror holder base 503 is fixed to a jig, whereas the movable mirror holder base 520 to which the mirror holder 501 holding the convex mirror 28 has been previously attached is fixed to a adjustment jig capable of adjusting its position in X′ and Y′ axes directions. Then, the position of the movable mirror holder 502 with respect to the fixed mirror holder 503 is set to an initial position by displacements in X′ and Y′ axes directions, followed by fixation of the movable mirror holder base 502 with respect to the fixed mirror holder base 503 by inserting the screws 507 through the through holes 502d and engaging them to the screw holes 503b of the fixed mirror holder base 503.

Then, procedures for a position adjustment of the convex mirror 28 to the mirror holding component 45 will be described. As the position adjustment of the convex mirror 28, there are three different procedures, i.e., a method using a collimator (reflection-type decentration meter), a method using a master engine, and a method using a length gauge. The method using the collimator is applicable only when the convex mirror 28 is a spherical surface mirror.

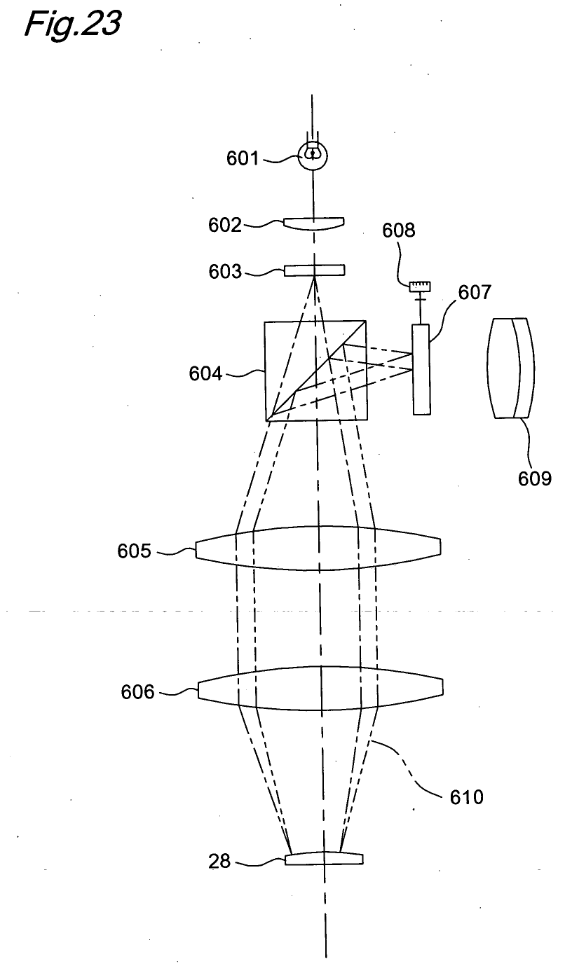

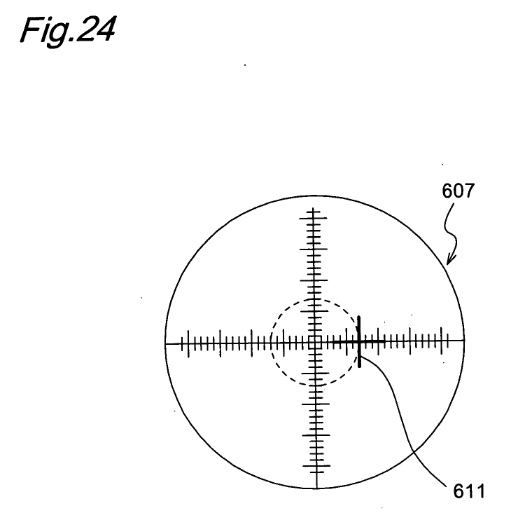

As shown in FIG. 23, the collimator is provided with a lamp 601, a condenser lens 602, a cross-shape chart 603, a beam splitter 604, a collimator lens 605, a relay lens 606, an eyepiece chart 607, micrometer 608, and an eyepiece lens 609. When the adjustment is executed, the fixed mirror holder 503 of the mirror holding component 45 is aligned with an optical axis of the collimator lens 605 and relay lens 606. A light beam emitted from the lamp 601 and transmitted through the cross-shape chat 603 via the condenser lens 602. The light beam is further transmitted to the beam splitter 604, collimator lens 605, and relay lens 606, and then the convex mirror 28 to be reflected. The light beam reflected by the convex mirror 28 is transmitted again through the relay lens 606 and collimator lens 605 and reflected by the beam splitter 604. The light beam reflected by the beam splitter 604 forms an image of the cross-shape chart 603 on the eyepiece chart 607 (see a reference numeral “611” in FIG. 24). If the convex mirror 28 is decentered with the optical axis of the collimator lens 605 and relay lens 606 (see two-dot chain lines 610 in FIG. 23), an image 611 of the cross-shape chart 603 observed through the eyepiece lens 609 is shifted with respect to the eyepiece chart 607 as shown in FIG. 24. With reference to the image 611 of the cross-shape chart 603 on the eyepiece chart 607, the movable mirror holder base 502 is displaced and/or rotated with respect to the fixed mirror holder base 503 for adjustment.

The master engine is a combination of the lower and upper pedestal components 11 and 12 on which the three curved mirrors other than the convex mirror 28 (the concave mirror 25, first free-form curved mirror 30, and second free-form curved mirror 31), the aberration correction plates 27 and 29, and chart is fixed in a status where the positions and the inclinations thereof are adjusted. The mirror holding component 45 is attached to the master engine. Then, the chart (refer to a reference numeral “43” in FIG. 19) is projected and displayed on the screen 9 through the projection optical system 6 constituted in the master engine. With reference to the chart displayed on the secreen 9, the mirror holder base 502 is displaced and/or rotated with respect to the fixed mirror holder base 503 for adjustment. The chart may be a pattern formed on a glass plate or modulated light beam by the DMD 3. Further, the master engine can be other holding components other than the lower and upper pedestal components 11 and 12 to the above-mentioned optical devices are attached.

Referring to FIG. 20, in case of using the length gauge, after the fixed mirror holder base 503 is attached to a jig of the length gauge, predetermined portions of the movable mirror holder 502, i.e., for measurement surface 502e for measuring inclinations, one points of a measurement surface 502f for the X′ axis direction, and two points of a measurement surfaces 502g are measured. Then the movable mirror holder base 502 is displaced and/or rotated with respect to the fixed mirror holder base 503 for adjustment so to keep the measured distances within predetermined tolerance levels. The reason for measuring the distances of the two points of the measurement surface 502f for the X′ axis direction is to measure an amount of rotation around the Z′ axis.

### Sixth Embodiment

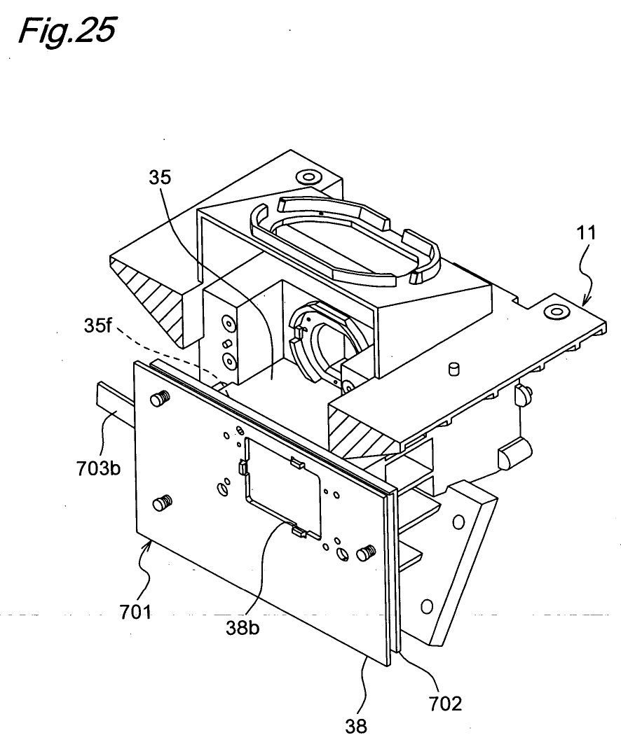

The projection optical systems according to the first and second embodiment can be provided with a focus adjustment mechanism 701 as shown if FIGS. 25 to 28 for adjusting the position of the DMD 3 with respect to the concave mirror (first mirror) 25 in the normal direction of the imager formation surface of the DMD 3. The focus adjustment mechanism 701 is provided with a image formation device holding plate 38 for holding DMD 3 (not shown in FIGS. 25 to 38), an attachment plate (attachment member) 702, and a rotation member (adjustment member) 703. As shown in FIG. 25, the focus adjustment mechanism 701 is attached to the lower pedestal component 11 so as to tightly close the opening 35f of the first tubular portion 35. Specifically, the focus adjustment mechanism 701 is positioned with respect to the opening 35f by inserting positioning bosses (not shown) formed on the edge 35i of the opening 35f into a pair of positioning hole 702a formed on the attachment plate 702. Further, by engaging screws (not shown) inserted through four through holes 702b formed on the attachment plate 702 to screw fixing engagement portions formed the opening 35f, the focus adjustment mechanism 701 is fixed to the lower pedestal component 11.

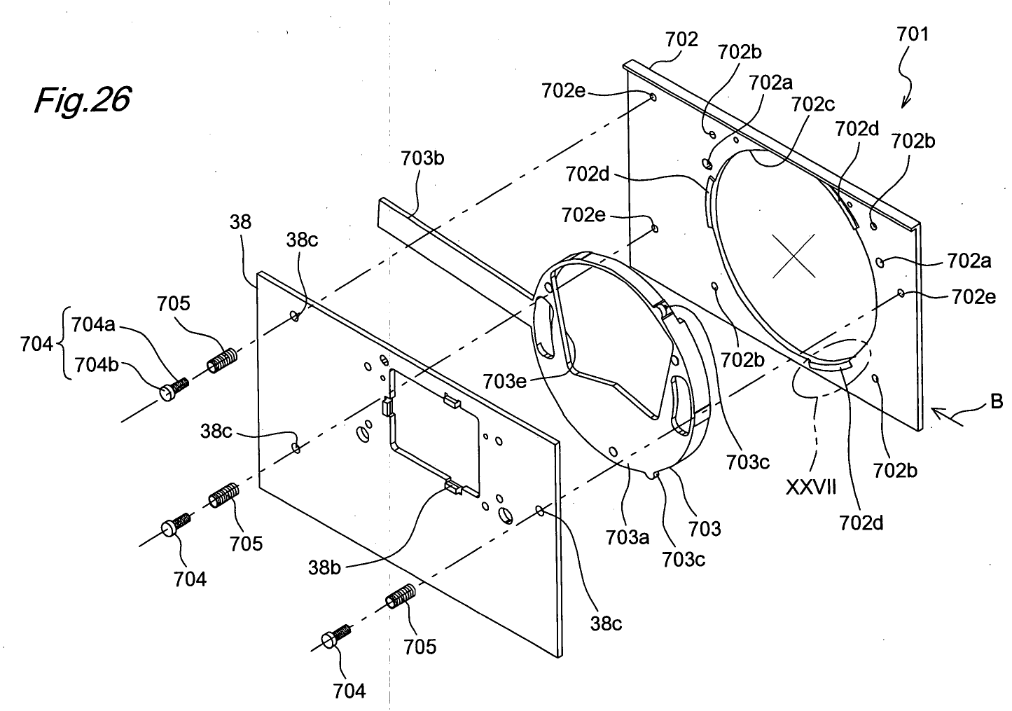

The attachment plate 702 is formed with a support hole 702c penetrating the attachment plate in a thickness direction thereof and having a circular shape. Further, on a back side (near side in FIG. 26) of the attachment plate 702, three slope portions 702d are formed along a peripheral of the support hole 702c with intervals. As most clearly shown in FIG. 28, each of the slope portions 702d has a configuration where an amount of projection from the back side of the attachment plate 702 is gradually increased toward a counterclockwise direction with respect to a center of the support hole 702c viewing from the back side of the attachment plate 702. Further, three screw holes 702e for connection of the image formation device holding plate 38 are formed in the attachment plate 702.

The rotation member 703 is provided with a flattened cylindrical portion 703a with a closed back side and an opened front side and operation lever portion 703b extending in a radial direction of the cylindrical portion 703a. An outer diameter of the cylindrical portion 703a is set to slightly smaller than a diameter of the support hole 702c. The cylindrical portion 703a is inserted through the support hole 702c so as to be projected from a front side of the attachment plate 702. By this engagement of the cylindrical portion 703a to the support hole 702c, the rotary member 703 is rotatably supported to the attachment plate 702. On an outer peripheral wall of the cylindrical portion 703a, three projections 703c projecting to the attachment plate 702 are provide with intervals. These projections 703c are respectively abutted or contacted to the slope portions 702d. As described below, each of the slope portions 702d acts as a cam, and each of the projections 703c acts as a cam follower. On the closed end of the cylindrical portion 703a, a window 703e is formed. The window 703e is formed so as that the DMD 3 on the image formation device holing plate 38 is always opposed to the convex mirror 25 regardless of a rotational angular position described later of the rotary member 703.

Holding portions or crows 38b are provided on the image formation device holding plate 38. Further, three through holes 38c penetrating in a thickness direction are formed on the image formation device holding plate 38. A diameter of each of the through hole 38c is sufficiently larger than that of a screw shaft 704a of screw (supporting mechanism) 704 for connection to the attachment plate 702.

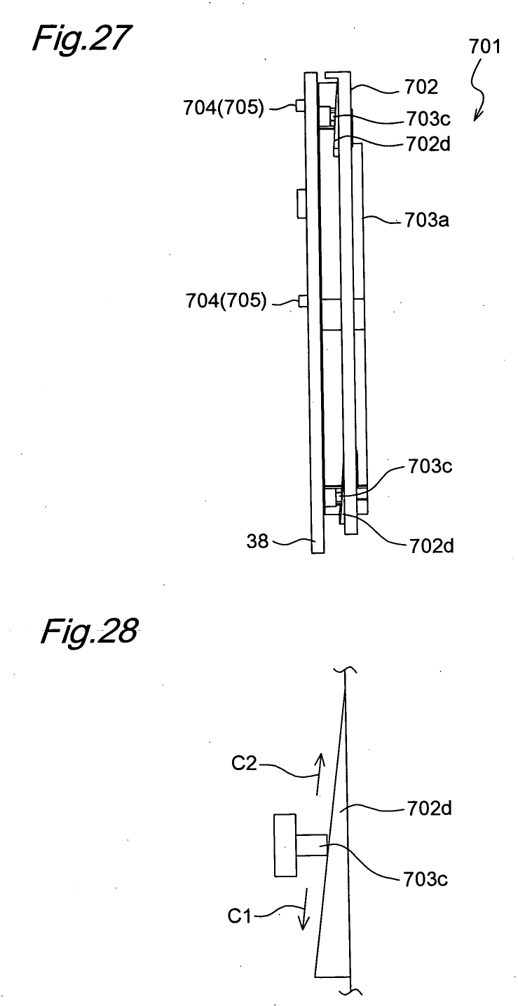

Referring to FIGS. 26 and 27, the attachment plate 702 and the image formation device holding plate 38 is connected with each other by the screws 704 with the rotary member 703 being interposed between them. Specifically, the cylindrical portion 703a of the rotary member 703 is engaged in the support hole 702c of the attachment plate 702, and a tip end side of the operation lever portion 703b of the rotary member 703 is projected outwardly from the attachment plate 702 and the image formation device holding plate 38. The screws 704 is inserted through the through hole 38c from the back side to the image formation device holding plate 38 with coil springs (urging member) 705 surrounding the screw shafts 704. The screws 704 are further fitted into the screw holes 702e. The image formation device holding plate 38 is supported by the screw shaft 70 of the screw 704 so that it can move forward and backward with respect to the attachment plate 702. Further, the image formation device holding plate 38 is elastically biased or urged in a direction approaching to the attachment plate 702 by the coil springs 705. The elastic urging force assures that the image formation device holding plate 38 is always abutted or contacted to the rotary member 703 and that the projections 703c of the rotary member 703 are always contacted to the slope portions 702d of the attachment plate.

A rotation of the operation lever portion 704b in the counterclockwise direction with respect to the center of the support hole 702c viewing from the back side of the attachment plate 702 moves the projections 703c on the slope portions 702d of the attachment plate 702 in a direction shown by an arrow C1 shown in FIG. 28. This results in that the image formation device holding plate 38 pushes by the rotary member 703 and the DMD 3 is moved in a direction away from the concave mirror 25. Contrarily to this operation, a rotation of the operation lever portion 704b in a clockwise direction moves the projections 703c on the slope portions 702d in a direction shown by an arrow C2 shown in FIG. 28. This decreases the amount of projection of the rotary member 703 from the back side of the attachment plate 702, resulting in that the image formation device holding plate moves so as that move the DMD 3 toward the concave mirror 25. As described above, by the operation of the operation lever portion 703b to set the rotary angular potion thereof, a distance from the DMD 3 to the concave mirror 25 can be infinitely adjusted.

Where the DMD 3 is attached to the image formation device holding plate 38 so that it can be translated in the Y axis direction, translated in the Z axis direction, and rotated in the X axis direction as in the projection optical system 6 of the first embodiment, the focus adjustment by the focus adjustment mechanism 701 (translation in the X axis direction) can be executed after completion of the adjustment by the translation in Y axis direction, translation in Z axis direction, and rotation in X axis direction (Step S 11-9 in FIG. 11).

Without being limited to the embodiments disclosed, the present invention may be variously modified.

First, although the present invention has been described with the orthogonal coordinate system (X axis, Y axis, Z axis) local to the curved mirrors, 25, 28, 30, 31 of the projection optical system 6 and the DMD 3 being defined as described before, the parallel movement and rotation of the curved mirrors 25 to 31 and the DMD 3 do not necessarily need the strictly defined orthogonal coordinate systems as reference. For example, the concave mirror 25 may be parallely moved and rotated by using first to third axes as reference, the first axis being an axis passing an intersection between the reference light beam R and the concave mirror 25, existing inside an incidence plane of the reference light beam R incident into the concave mirror 25 and being in the range of an incident direction of the reference light beam R incident into the concave mirror 25 and in the range of a reflection direction of the reference light beam R from the concave mirror 25, the second axis being an axis parallel to the incidence plane of the reference light beam R incident into the concave mirror 25 and perpendicular to the first axis, and the third axis being an axis perpendicular to the first axis and the second axis. It is to be noted that the first axis includes the X axis of the concave mirror 25 defined as above. As for the convex mirror 28, similarly, instead of the above-defined X axis, Y axis and Z axis, an axis passing the intersection between the reference light beam R and the convex mirror 28, existing inside an incidence plane of the reference light beam R incident into the convex mirror 28 and being in the range of an incident direction of the reference light beam R incident into the convex mirror 28 and in the range of a reflection direction of the reference light beam R from the convex mirror 28 is defined as a fourth axis, an axis parallel to the incidence plane of the reference light beam R incident into the convex mirror 28 and perpendicular to the fourth axis is defined as a fifth axis, and an axis perpendicular to the fourth axis and the fifth axis is defined as a sixth axis, and these fourth to six axes may be used as reference of the parallel movement and rotation. Even in the case where the axes, serving as reference for the parallel movement and rotation of mirrors or the like, do not completely match the axes described in the embodiments due to the difference in optical structure and mechanical structure, the present invention is still applicable and its effects can be attained.

The manufacturing method of the present invention is applicable to a projection optical system including at least four curved mirrors with an concave mirror and a convex mirror being disposed in order from the image formation device side, and the mirror surface may be any one of a spherical surface, an aspherical surface and a free surface. Moreover, the image formation device is not limited to the reflection type image formation device such as DMDs but may be a transmission type image formation device such as liquid crystal devices. Further, although the present invention has been described by taking the rear projection TV that is a rear projection-type image display apparatus as an example, the present invention is also applicable to a front projection-type image display apparatus that projects an image from the front of the screen.

Although the present invention has been fully described in conjunction with preferred embodiments thereof with reference to the accompanying drawings, various changes and modifications are possible for those skilled in the art. Therefore, such changes and modifications should be construed as included in the present invention unless they depart from the intention and scope of the invention as defined by the appended claims.

What is claimed is:

1. A method for manufacturing a projection optical system having a plurality of mirrors which reflect an image light modulated by an image formation device so as to be projected onto a screen, comprising:
attaching the mirrors to a pedestal, the mirrors including a first mirror placed closest to the image formation device on an optical path traveling from the image formation device to the screen and a second mirror placed next to the first mirror on the optical path;
fixing a position and an inclination of the second mirror; and
adjusting at least three axes for a position and an inclination of the first mirror.

2. The method according to claim 1, wherein a light beam passing an optical path traveling through a center of the image formation device and a center of an aperture of the projection optical system to a center of the screen is defined as a reference light beam,
wherein an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror is defined as a first axis,
wherein an axis parallel to the incidence plane of the reference light beam to the first mirror and perpendicular to the first axis is defined as a second axis,
wherein an axis perpendicular to the first and second axes is defined as a third axis, and
wherein the adjustment of the position and the inclination of the first mirror includes a translation along the first axis, a rotation around the second axis, and a rotation around the third axis.

3. The method according to claim 2, further comprising:
attaching the image formation device to the pedestal; and
adjusting a position of the image formation device by a translation of the image formation device along a short side thereof and a movement of the image formation device along a long side thereof after the adjustment of the position and the inclination of the first mirror.

4. The method according to claim 3, further comprising:
adjusting the position of the image formation device by a rotation of the image formation device around an axis along a normal axis of the image formation device.

5. The method according to claim 1, wherein the second mirror is fixed to a mirror holder which is to be fixed to the pedestal after the second mirror is fixed, and
wherein the mirror holder is fixed to the pedestal after adjustment of at least three axes for a position and an inclination of the second mirror to the mirror holder.

6. The method according to claim 5, wherein the second mirror is a spherical surface mirror, and
wherein the adjustment of at least three axes for the position and the inclination of the second mirror to the mirror holder comprising:
attaching the mirror holder to a jig of a collimator; and
displacing and/or rotating the second mirror with respect to the mirror holder so as to keep an amount of decentration measured by the collimator within a predetermined tolerance level.

7. The method according to claim 5, wherein the adjustment of at least three axes for the position and the inclination of the second mirror to the mirror holder comprising:
providing a master engine to which at least the first mirror and a chart are fixed in a manner where adjustments of positions and inclinations have been completed,
attaching the mirror holder to the master engine;
projecting the chart on the screen through the projection optical system constructed in the master engine; and
displacing and/or rotating the second mirror with respect to the mirror holder on the basis of an image of the chart projected on the screen.

8. The method according to claim 5, wherein the adjustment of at least three axes for the position and the inclination of the second mirror to the mirror holder comprising:
attaching the mirror holder to a jig of a length gauge; and
displacing and/or rotating the mirror with respect to the mirror holder so as to keep positions of at least two end faces of the mirror holder measured by the length gauge within a predetermined tolerance level.

9. A method for manufacturing a projection optical system having a plurality of mirrors which reflect an image light modulated by an image formation device so as to be projected onto a screen, comprising:
attaching the mirrors to a pedestal, the mirrors including a first mirror placed closest to the image formation device on an optical path traveling from the image formation device to the screen and a second mirror placed next to the first mirror on the optical path;
fixing a position and an inclination of the image formation device; and
adjusting at least three axes for a position and an inclination of the first mirror.

10. The method according to claim 9, wherein a light beam passing an optical path traveling through a center of the image formation device and a center of an aperture of the projection optical system to a center of the screen is defined as a reference light beam,
wherein an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror is defined as a first axis,
wherein an axis parallel to the incidence plane of the reference light beam to the first mirror and perpendicular to the first axis is defined as a second axis,
wherein an axis perpendicular to the first and second axes is defined as a third axis, and
wherein the adjustment of the position and the inclination of the first mirror includes a translation along the first axis, a translation along the second axis, and a translation along the third axis.

11. The method according to claim 10, wherein an axis passing an intersection between the reference light beam and the second mirror, existing in an incidence plane of the reference light beam to the second mirror, and directed to a direction between an incident direction of the reference light beam to the second mirror and a reflection direction of the reference light beam from the second mirror is defined as a fourth axis,
wherein an axis parallel to the incidence plane of the reference light beam to the second mirror and perpendicular to the fourth axis is defined as a fifth axis,
wherein an axis perpendicular to the fourth and fifth axes is defined as a sixth axis, and
wherein at least one of first and second adjustments is executed after adjustment of the position and the inclination of the first mirror, the first adjustment including the translation of the first mirror along the first axis by an amount and a translation of the second mirror along the fifth axis by same amount, the second adjustment including the translation of the first mirror along the third axis by an amount and a translation of the second mirror along the sixth axis by same amount.

12. The method according to claim 1, wherein an image formation device holder to which the image formation device is attached is mounted on the pedestal in such a way that an inclination between a mounting reference plane for mounting the image formation device holder on the pedestal and the image formation surface of the image formation device is not more than ⅙ degree.

13. A projection optical system, comprising:
a plurality of mirrors which reflect an image light modulated by an image formation device so as to be projected onto a screen, which includes a first mirror placed closest to the image formation device on an optical path traveling from the image formation device to the screen and a second mirror placed next to the first mirror on the optical path;
a pedestal on which the image formation device, the first mirror, and the second mirror are mounted; and
a mirror adjustment mechanism for supporting the first mirror so that the first mirror can be translated along a first axis, rotated around a second axis, and rotated around a third axis with respect to the pedestal, the first axis being an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror, the second axis being an axis parallel to the incidence plane of the reference light beam to the first mirror and perpendicular to the first axis, and the third axis being an axis perpendicular to the first and second axes.

14. The projection optical system according to claim 13, wherein the mirror adjustment mechanism comprises:
a mirror holder for holding the first mirror;
a mirror holder base fixed onto the pedestal;
a holder retainer for retaining the mirror holder onto the mirror holder base in such a way as to allow parallel translation of the mirror holder in the first axis direction but to restrict translation of the mirror holder in the second and third axes directions; and
a positioning mechanism capable of positioning at least three portions of the mirror holder with respect to the mirror holder base in the first axis direction, the three portions being disposed symmetrically with respect to a first symmetric axis parallel to the second axis passing a center of the first mirror and a second symmetric axis parallel to the third axis passing the center of the first mirror.

15. A projection optical system according to claim 13, further comprising an optical path length adjustment mechanism which includes:
a pair of wedge-type optical elements placed between the image formation device and the first mirror and having inclined surfaces inclined with respect to a normal direction of a image formation surface and contacted with each other; and
a position adjustment mechanism capable of adjusting relative positions of the optical elements with maintaining the inclined surfaces being in contact with each other.

16. The projection optical system according to claim 13 further comprising a focus adjustment mechanism for adjusting a position of the image formation device in a normal direction of the image formation surface with respect to the first mirror.

17. The projection optical system according to claim 16, wherein the focus adjustment mechanism comprises:
an image formation device holder for holding the image formation device;
an attachment member fixed to the pedestal;
a supporting mechanism for supporting the image formation device holder to the attachment member so as to be moved forward and backward with respect to the image formation device holder;
a urging member for elastically urging the imager formation device holder toward a direction where the image formation device holder approaches the attachment member; and
a adjustment member rotatably held between the image formation device holder and the attachment member for moving the image formation device holder in a direction away from the attachment member against an urging force of the urging member according to a rotational position thereof.

18. A projection optical system, comprising:
a plurality of mirrors which reflect an image light modulated by an image formation device so as to be projected onto a screen, which includes a first mirror placed closest to the image formation device on an optical path traveling from the image formation device to the screen and a second mirror placed next to the first mirror on the optical path;
a pedestal on which the image formation device, the first mirror, and the second mirror are mounted; and
a mirror adjustment mechanism for supporting the first mirror so that the first mirror can be translated along a first axis, translated along a second axis, and translated along a third axis with respect to the pedestal, the first axis being an axis passing an intersection between the reference light beam and the first mirror, existing in an incidence plane of the reference light beam to the first mirror, and directed to a direction between an incident direction of the reference light beam to the first mirror and a reflection direction of the reference light beam from the first mirror, the second axis being an axis parallel to the incidence plane of the reference light beam to the first mirror and perpendicular to the first axis, and the third axis being an axis perpendicular to the first and second axes.

19. The projection optical system according to claim 18,
wherein the mirror adjustment mechanism comprises:
a first adjustment plate mounted on the pedestal displaceably in the first axis direction;
a second adjustment plate mounted on the first adjustment plate displaceably in the third axis direction; and
a mirror holder for holding the first mirror mounted on the second adjustment plate displaceably in the second axis direction.

20. A projection optical system according to claim 18, further comprising an optical path length adjustment mechanism which includes:
a pair of wedge-type optical elements placed between the image formation device and the first mirror and having inclined surfaces inclined with respect to a normal direction of a image formation surface and contacted with each other; and
a position adjustment mechanism capable of adjusting relative positions of the optical elements with maintaining the inclined surfaces being in contact with each other.

21. The projection optical system according to claim 18 further comprising a focus adjustment mechanism for adjusting a position of the image formation device in a normal direction of the image formation surface with respect to the first mirror.

22. The projection optical system according to claim 21, wherein the focus adjustment mechanism comprises:
an image formation device holder for holding the image formation device;
an attachment member fixed to the pedestal;
a supporting mechanism for supporting the image formation device holder to the attachment member so as to be moved forward and backward with respect to the image formation device holder;
a urging member for elastically urging the imager formation device holder toward a direction where the image formation device holder approaches the attachment member; and
a adjustment member rotatably held between the image formation device holder and the attachment member for moving the image formation device holder in a direction away from the attachment member against an urging force of the urging member according to a rotational position thereof.
